(19) United States
(12) Patent Application Publication
(10) Pub. No.: US 2025/0339331 A1
(43) Pub. Date: Nov. 6, 2025

(54) Walker Tray for Use with a Walker Apparatus

(71) Applicant: Peak Degrees Holdings LLC, Trophy Club, TX (US)

(72) Inventor: Christopher Pesek, Trophy Club, TX (US)

(21) Appl. No.: 19/088,621

(22) Filed: Mar. 24, 2025

Related U.S. Application Data
(63) Continuation-in-part of application No. 18/655,824, filed on May 6, 2024, now Pat. No. 12,257,204.

(51) Int. Cl. A61H 3/04; A47G 23/06; A61H 3/00

(52) U.S. Cl. CPC A61H 3/04; A47G 23/0641; A61H 2003/004; A61H 2201/0161; A61H 2201/1253

(57) ABSTRACT

A walker tray is removably attachable to a walker for enabling a user to support items. In some embodiments, the walker tray is light-transmissive for enabling a user to see through the tray. The walker tray includes a tray-to-walker attachment mechanism, and in this regard, some embodiments either include a pair of laterally opposed handle-receiving apertures or resilient clip elements. In those embodiments having handle-receiving apertures for mounting the tray upon the walker, each aperture has an aperture and an aperture width. The aperture lengths and aperture widths are configured to receive at least upper handle portions of a walker. Each of the handle-receiving apertures are defined inwardly by an inner leg-engaging edge configured to engage at least a forward leg portion and a rearward leg portion. Together the forward and rearward leg portions and the inner leg-engaging edge are cooperable to support the walker tray upon the walker.

### PRIOR HISTORY

This application is a Continuation-in-Part application claiming the benefit of U.S. patent application Ser. No. 18/655,824 filed in the United States Patent and Trademark Office on 6 May 2024, the specifications and drawings of which are hereby incorporated by reference thereto.

### FIELD OF THE INVENTION

The present invention relates generally to an accessory for a walker apparatus, and more particularly to a walker tray for use with a walker apparatus to accessorize the same and enhance the utilitarian features thereof.

### BRIEF DESCRIPTION OF THE PRIOR ART

As the world's population ages, given enough time, it is inevitable that both men and women will eventually require the use of a walking aid. There are three general categories of these aids. They are: (1) Canes; (2) (Folding) Walkers; and (3) Rollator Walkers. The presently disclosed subject matter is directed primarily for use with category 2 or (folding) walkers. Folding walkers are by far the most widely used product when it comes to the walker category of walking aids. A walker apparatus or walking frame is a device that gives support to maintain balance or stability to a user while walking most commonly due to mobility disability most commonly cause by age-related frailty.

A walker is also commonly used by those who are recuperating from leg or back injuries or persons having problems with walking or with mild balance problems. In the United States, U.S. Pat. No. 2,656,874 issued to William C. Robb in October 1953 with an effective filing date of 11 Aug. 1949. Elmer Ries then later patented certain walker designs as exemplified by the subject matter of U.S. Pat. No. 2,996,070, issued 15 Aug. 1961 and U.S. Pat. No. 3,165,112, issued 12 Jan. 1965. Some consider the first modern walker to be embodied by the subject matter disclosed and described in U.S. Pat. No. 3,517,677, issued to Alfred A. Smith on 30 Jun. 1970.

The basic design consists of a lightweight frame that is about waist high, approximately 12 inches or 30 centimeters deep and slightly wider than the user. Some walkers have adjustable heights and are also provided in pediatric and bariatric sizes. In a preferred application, a walker should have upper handle portions set at a height that is comfortable for the user, but will allow the user to maintain a slight bend in their arms for allowing improved blood circulation through the arms as the walker is used. The front two legs of the walker may or may not have wheels attached, depending on the strength and abilities of the person using it. It is also common to see wheels or glides on the back legs of a walker with wheels on the front. Users may sometimes outfit the bottom portions of the legs with felt products or tennis balls with holes cut in them for use on smooth surfaces common to institutions for the aged.

A user walks with the frame surrounding their front and sides and their hands provide additional support by holding on to the top of the sides of the frame. Traditionally, a walker is picked up and placed a short distance ahead of the user. The user then walks to it and repeats the process. With the use of wheels and glides, the user may push the walker ahead as opposed to picking it up. This makes for easier use of the walker, as it does not require the user to use their arms to lift the walker. This is beneficial for those with little arm strength. Related to the traditional walker is hemi-walker, a walker about half the size of a traditional walker which is intended for use by persons whose dexterity is limited or non-existent in one hand or arm. These walkers are more stable than a quad cane, but are generally not recommended as highly as a traditional walker for those who are able to use the same since the traditional walker provides laterally opposed arm support stability.

Walker trays later developed to increase the utilitarian features of a traditional walker and enable users to support items of use upon the walker tray for ease of reach and accessibility. U.S. Pat. No. 4,708,274 ('274 Patent), issued to Roche for example, discloses a Removable Tray Apparatus for a Walker. The '274 Patent describes an apparatus for use with a walker of a type having four vertically disposed legs which are adapted to contact the floor at the bottom thereof. Handles are provided on each side of the walker and first and second horizontal elongated members are disposed below each of the handles. A rigid tray is provided for extending over and above the first and second horizontal elongated members, with each side of the tray having first and second downwardly extending flanges thereon for preventing the tray from falling off of the first and second horizontal elongated members. The tray is not bolted or fastened to the walker itself so that it can be easily and quickly removed from or placed onto the first and second horizontal elongated members.

In some applications, a walker seat is provided for enabling a user to sit thereupon during transit so as to alleviate the user from over-exertion. U.S. Pat. No. 4,907,839 ('839 Patent), issued to Rose et al. for example, discloses a Walker with Folding Seat. The '839 Patent describes a walker with a retrofittable foldable sheet has at least one front leg and a plurality of rear legs. Clamps attach to each of the legs and a seat extends over and is supported by the clamps. A guide connects a portion of the seat to at least one of the forward legs to allow the seat to be moved from an in-use position to a storage position against the forward legs. The seat has a receptacle for each clamp when positioned for use and a receptacle for each front clamp and for the guide when in storage. Clips are used to hold the walker against the forward legs of the walker.

The presently disclosed subject matter is more particularly directed to walker trays as further exemplified by the subject matter of U.S. Pat. No. 5,217,032 ('032 Patent), issued to Jobst. The '032 Patent discloses a Tray for a Walker Frame on which tray various items may be transported while the user's hands are engaged in maneuvering the walker frame. The tray is slide coupled in position such that the tray may be extended forward of the frame to allow a person to stand within the confines of the frame in the course of manipulating the frame. When desired, the user may draw the tray back more fully within the confines of the frame for use as a small table or work surface.

U.S. Pat. No. 5,273,063 ('063 Patent), issued to Farr et al., discloses a Folding Tray for Invalid Walkers. The '063 Patent describes a fold-down detachable utility tray for invalid walkers comprising a generally rectangular tray frame in combination with a pair of locking, fold-down arms each having spring clips for securement to the upright members of walker. In a preferred embodiment, the center of gravity of the tray is located over the pivot point of the locking arms, so that the weight of objects placed on the tray causes the arms to lock more tightly, promoting stability of the tray. The locking arms each comprise an elongated angle bracket provided with a pivot. An actuator arm has a first end movably connected to the pivot and a second end slidingly engaged in a slot in the tray frame. One end of the slot is provided with an upwardly extending locking notch to hold the arm in the extended position.

U.S. Pat. No. 5,642,748 ('748 Patent), issued to Obitts, discloses a Walker Tray. The '748 Patent describes a pivoting tray for use with a walker. A pair of link arms disposed on each side of the tray provide for ease of movement between a first, operative position disposed between side frame assemblies of the walker, to a second, storage position generally vertically oriented in front of the walker. The mounting brackets are adapted for use with either a single actuator or dual release style of walker. Moreover, the mounting bracket is symmetrical for use on both the right-hand and left-hand sides of the walker, thereby reducing manufacturing costs and inventory.

U.S. Pat. No. 6,883,529 ('529 Patent), issued to Kvaternik, discloses a Removable Tray for a Walker. The '529 Patent describes a walker and tray combination including a first pair of spaced-apart legs connected to one another by a first upper connecting bar extending between respective points adjacent an upper end of each of the first pair of legs. The combination also includes a second pair of spaced-apart legs connected to one another by a second upper connecting bar extending between respective points adjacent an upper end of each of the second pair of legs. At least one strut connects the first pair of legs to the second pair of legs, and a connector is configured to selectively retain the tray in one of a primary position or a secondary position.

U.S. Pat. No. 7,712,477 ('477 Patent), issued to McCarthy, discloses a Tray for a Walker. The '477 Patent describes a tray including a generally rigid tray base having an essentially rectangular shape with a front long side, a back long side, a first short side and a second short side wherein the tray has a length that extends to or past laterally opposed support members formed on the walker. In some embodiments, the tray base comprises a ridge extending along the sides of the tray; a strap positioned at or near the back long end; and a pair of hinge members positioned at or near the forward legs. The length of the tray is greater than the distance between support members of laterally opposed supports and the width of the tray is less than the length of the support members of the laterally opposed supports.

US Design Patent No. D745,442 ('442 Patent), issued to McCuen et al on 15 Dec. 2015, discloses a Transparent Walker Tray. The ornamental design of the Transparent Walker Tray shows a tray having front long side, a back long side, and laterally opposed short sides wherein the tray has a length that extends to or past laterally opposed support members formed on the walker. A pair of laterally opposed handle-receiving apertures are formed in the tray in parallel relation to the laterally opposed short sides inwardly adjacent thereto. The Transparent Walker Tray further shows a third aperture formed through a tray support portion of the tray in adjacency to a first of the laterally opposed handle-receiving apertures.

The prior art thus perceives a need for a removable walker tray that in some embodiments is transparent for enabling a user to perceive objects located underneath the walker tray as the user maneuvers the walker as outfitted with the tray and configured to provide a relatively more universally removably attachable tray for use with a variety of walker designs. The presently disclosed subject matter attempts to provide such a solution as summarized in more detail hereinafter.

### GENERAL DESCRIPTIONS

There is provided in accordance with an embodiment of the presently disclosed subject matter a walker tray for use with a walker apparatus having laterally opposable upper handle portions each of which extend in a handle plane. Each handle portion is supportable within the handle plane by a forward leg and a rearward leg, which forward and rearward legs are angled relative to one another. The walker tray according to the presently disclosed subject matter comprises a forward edge, a rearward edge, laterally opposed edges, and a tray support portion extending intermediate the forward, rearward, and laterally opposed edges. The tray support portion comprises an upper tray surface and a lower tray surface.

The walker tray according to the presently disclosed subject matter further comprises a pair of laterally opposed handle-receiving apertures extending through the tray support portion inwardly adjacent the laterally opposed edges each of which extend along an aperture plane intersecting the forward and rearward edges. Each of the handle-receiving apertures has an aperture length extending along the aperture planes and an aperture width extending orthogonally relative to the aperture planes. The aperture lengths and aperture widths are configured to receive at least the upper handle portions of the walker apparatus. Each of the handle-receiving apertures are defined inwardly by an inner leg-engaging edge configured to engage at least a forward leg portion and a rearward leg portion, which forward and rearward leg portions and the inner leg-engaging edge together cooperate to support the walker tray upon the walker apparatus.

In some embodiments, at least the tray support portion of the walker tray is formed from a light-transmissive material for allowing light to pass therethrough and for enabling a user to see through at least the tray support portion of the walker tray. In some embodiments, at least the tray support portion is formed from a colored light-transmissive material for altering the transmittance thereof. In some embodiments, the aperture planes are obliquely angled relative to a forward direction. In some embodiments, the aperture planes are obliquely angled relative to the laterally opposed edges. In some embodiments, the walker tray comprises an upper peripheral edge ridge formation extending along the forward, rearward and laterally opposed edges such that an upper edge portion of the upper peripheral edge ridge formation extends in an upper edge plane in parallel relation to the upper tray surface.

In some embodiments, the walker tray comprises a bottom edge extending in a lower edge plane parallel to the upper ridge plane, the upper tray surface, and the lower tray surface. In some embodiments, each handle-receiving aperture comprises a peripheral aperture ridge formation such that a first upper ridge portion of the upper peripheral aperture ridge formation extends in a first upper ridge plane intermediate the upper tray surface and the upper edge plane in parallel relation thereto. In some embodiments, each handle-receiving aperture comprises a radiused portion inwardly adjacent the forward edge and the rearward edge. In some embodiments, the radiused portions extend convexly relative to one another intermediate the aperture width coextensively therewith.

In some embodiments, forward edge comprises a forward edge radius and the rearward edge comprises a rearward edge radius, the forward and rearward radii being convex relative to a user positioned at the rearward edge. In some embodiments, the rearward edge radius is lesser than the forward edge radius. In some embodiments, the walker tray according to the presently disclosed subject matter comprises at least a third aperture extending through the upper and lower tray surfaces. In some embodiments, the third aperture comprises a third upper peripheral aperture ridge formation that a third upper ridge portion of the third upper peripheral aperture ridge formation extends in a second upper ridge plane intermediate the upper tray surface and the upper edge plane in parallel relation thereto. In some embodiments, the first and second upper ridge planes are coplanar. In some embodiments, the third aperture comprises a lower peripheral aperture ridge formation that a lower ridge portion of the lower peripheral aperture ridge formation extends in a lower ridge plane intermediate the lower tray surface and the lower edge plane in parallel relation thereto.

In some embodiments, the walker tray according to the presently disclosed subject matter may further comprises a removable lens element. The removable element is configured to removably attach to at least the third aperture for refracting light passing therethrough. In some embodiments, the removable lens element is configured to seat upon the third upper peripheral aperture ridge formation. In some embodiments, the removable lens element is characterized by comprising a biconvex lens for optionally providing a magnifier lens element to users. In some embodiments, at least one of the forward edge, the rearward edge and the laterally opposed edges comprises a hanger mechanism for enabling a user to hang a utility bag upon the walker tray. In some embodiments, the hanger mechanism is characterized by at least one of a strap-receiving aperture and a loop supporting hook member.

In some embodiments, a walker tray attaches to a walker apparatus having laterally opposable handle portions each of which extend in a handle plane having a vertical dimension. Each handle portion is supportable within a respective handle plane by at least one leg. In some embodiments, the walker tray according to the presently disclosed subject matter comprises a forward portion, a rearward portion, laterally opposed portions, and a tray support portion extending intermediate said forward, rearward, and laterally opposed portions. In some embodiments, the walker tray further comprises a tray-to-walker attachment mechanism configured to removably attach the walker tray to the walker apparatus so as to position the tray support portion in a support plane for providing a horizontal support surface for enabling a user to support items thereupon. In some embodiments, at least the tray support portion is formed from a light-transmissive material for allowing light to pass therethrough and for enabling the user to see through at least the tray support portion of the walker tray.

In some embodiments, the tray-to-walker attachment mechanism is characterized by a pair of laterally opposed handle-receiving apertures extending through the tray support portion inwardly adjacent the laterally opposed portions each of which extend along an aperture plane intersecting the forward and rearward portions. In some embodiments, each of the handle-receiving apertures has an aperture length extending along a respective aperture plane and an aperture width extending orthogonally relative thereto. In some embodiments, the aperture lengths and aperture widths are configured to receive at least the opposable handle portions.

In some embodiments, the opposable handle portions are supportable within the handle planes by a forward leg and a rearward leg. In some embodiments, the forward and rearward legs are angled relative to one another. In some embodiments, each of the handle-receiving apertures are defined inwardly by an inner leg-engaging edge configured to engage at least a forward leg portion and a rearward leg portion, said forward and rearward leg portions and said inner leg-engaging edges for wedge-supporting the walker tray upon the walker apparatus. In some embodiments, the aperture planes are obliquely angled relative to a forward direction.

In some embodiments, the tray support portion comprises at least one aperture and a removable lens element. In some embodiments, the removable element is configured to removably attach to the at least one aperture for refracting light passing therethrough. In some embodiments, the at least one aperture comprises an upper peripheral aperture ridge formation. In some embodiments, the removable lens element is configured to seat upon the upper peripheral aperture ridge formation.

In some embodiments, the tray-to-walker attachment mechanism is characterized by a plurality of resilient clip elements extending from at least two portions of said forward, rearward, and laterally opposed portions. In some embodiments, the resilient clip elements are attachable to first and second portions of the walker apparatus. In some embodiments, the plurality of resilient clip elements comprises paired sets of clip elements, each paired set of clip elements extending from at least two portions of said forward, rearward, and laterally opposed portions. In some embodiments, each paired set of clip elements extend from a main clip body. In some embodiments, each main clip body is pivotally attached to the laterally opposed portions such that the tray support portion is pivotal intermediate an object support configuration characterized by a horizontal orientation and a collapsed configuration characterized by at least a partially vertical orientation.

### BRIEF DESCRIPTION OF THE DRAWINGS

Other features and objectives of the presently disclosed subject matter will become more evident from a consideration of the following brief descriptions of patent drawings.

FIG. 1 is a first top perspective view of a first walker tray according to the presently disclosed subject matter as viewed from a first lateral edge of the first walker tray.

FIG. 2 is a second top perspective view of the first walker tray according to the presently disclosed subject matter as viewed from a second lateral edge of the first walker tray.

FIG. 3 is a first top plan view of the first walker tray according to the presently disclosed subject matter showing opposed handle-letting apertures in a first angle of inclination relative to opposed sides of the first walker tray such that forward ends of the opposed handle-letting apertures are angled inwardly.

FIG. 4 is a top plan view of a second walker tray according to the presently disclosed subject matter showing opposed handle-letting apertures in a second angle of inclination relative to opposed sides of the second walker tray such that rearward ends of the opposed handle-letting apertures are angled inwardly.

FIG. 5 is a top plan view of a third walker tray according to the presently disclosed subject matter showing opposed handle-letting apertures extending in parallel relation to opposed sides of the third walker tray.

FIG. 6 is a diagrammatic lateral view depiction of a generic walker tray according to the presently disclosed subject matter shown installed upon upper portions of a walker apparatus with parts of the walker tray broken away at “xx” to reveal otherwise hidden engagement points between the walker tray and the walker apparatus.

FIG. 7A is a second top plan view of the first walker tray according to the presently disclosed subject matter shown with a first coloration as mounted upon upper portions of a walker apparatus having parallel upright leg arrangements obliquely angled relative to the handle-letting apertures.

FIG. 7B is a third top plan view of the first walker tray according to the presently disclosed subject matter shown with a second coloration as mounted upon upper portions of a walker apparatus having obliquely angled upright leg arrangements axially aligned with the handle-letting apertures.

FIG. 8A is a second top plan view of the second walker tray according to the presently disclosed subject matter as mounted upon upper portions of a walker apparatus having parallel upright leg arrangements obliquely angled relative to the handle-letting apertures.

FIG. 8B is a third top plan view of the second walker tray according to the presently disclosed subject matter as mounted upon upper portions of a walker apparatus having obliquely angled upright leg arrangements axially aligned with the handle-letting apertures.

FIG. 9A is a second top plan view of the third walker tray according to the presently disclosed subject matter as mounted upon upper portions of a walker apparatus having obliquely angled upright leg arrangements obliquely angled relative to the handle-letting apertures such that forward portions of the upright leg arrangements are angled inwardly relative to the opposed sides of the third walker tray.

FIG. 9B is a third top plan view of the third walker tray according to the presently disclosed subject matter as mounted upon upper portions of a walker apparatus having obliquely angled upright leg arrangements obliquely angled relative to the handle-letting apertures such that rearward portions of the upright leg arrangements are angled inwardly relative to the opposed sides of the third walker tray.

FIG. 9C is a fourth top plan view of the third walker tray according to the presently disclosed subject matter as mounted upon upper portions of a walker apparatus having parallel upright leg arrangements axially aligned with the handle-letting apertures.

FIG. 10 is a bottom plan view of the first walker tray according to the presently disclosed subject matter.

FIG. 11 is a forward edge view of the first walker tray according to the presently disclosed subject matter.

FIG. 12 is a rearward edge view of the first walker tray according to the presently disclosed subject matter.

FIG. 13 is a first lateral edge view of the first walker tray according to the presently disclosed subject matter.

FIG. 14 is a second lateral edge view of the first walker tray according to the presently disclosed subject matter.

FIG. 15 is a cross-sectional top perspective view of the first walker tray according to the presently disclosed subject matter as sectioned along a plane extending equidistant intermediate the first and second lateral edges to show the planar structure of a tray support portion of the first walker tray.

FIG. 16 is an internal edge view of the cross-section of the first walker tray otherwise depicted in FIG. 15.

FIG. 17A is an enlarged fragmentary internal edge view of left portions of the cross-section of the first walker tray otherwise depicted in FIG. 16.

FIG. 17B is an enlarged fragmentary internal edge view of right portions of the cross-section of the first walker tray otherwise depicted in FIG. 16.

FIG. 18 is a cross-sectional top perspective view of the first walker tray according to the presently disclosed subject matter as sectioned along a plane extending lengthwise through a first handle-receiving aperture of two handle-receiving apertures of the first walker tray.

FIG. 19 is an internal edge view of the cross-section of the first walker tray otherwise depicted in FIG. 18.

FIG. 20 is an enlarged fragmentary internal edge view of left portions of the cross-section of the first walker tray otherwise depicted in FIG. 19.

FIG. 21 is a cross-sectional top perspective view of the first walker tray according to the presently disclosed subject matter as sectioned along a plane extending through a third aperture of the first walker tray.

FIG. 22 is an internal edge view of the cross-section of the first walker tray otherwise depicted in FIG. 21.

FIG. 23 is an enlarged fragmentary internal edge view of third aperture portions of the cross-section of the first walker tray otherwise depicted in FIG. 22.

FIG. 24 is a third top perspective view of the first walker tray according to the presently disclosed subject matter shown with an optional removable lens element in exploded relation relative to the first walker tray over the third aperture.

FIG. 25 is a top plan view of the first walker tray according to the presently disclosed subject matter shown with the optional removable lens element over the third aperture.

FIG. 26 is a cross-sectional view of the first walker tray according to the presently disclosed subject matter as sectioned along a plane extending through the third aperture and optional removable lens element in exploded relation relative to the first walker tray over the third aperture.

FIG. 27 is an enlarged fragmentary internal edge view of third aperture portions of the cross-section of the first walker tray otherwise depicted in FIG. 26 showing the removable lens element over the third aperture.

FIG. 28A is a first sequential depiction of a user positioned at a first position rearward of a generic walker apparatus before stepping forward into a space defined by the walker apparatus.

FIG. 28B is a second sequential depiction of a user positioned at a second position relative to a generic walker apparatus after stepping forward into the space defined by the walker apparatus.

FIG. 28C is a third sequential depiction and perspective view of the user looking downwardly toward an object on the floor in a forward direction relative to the walker apparatus while the user is positioned in the space defined by the walker apparatus.

FIG. 29A is a first sequential depiction of a user positioned at a first position rearward of a generic walker apparatus outfitted with a generic walker tray with a user looking in a forward direction.

FIG. 29B is a second sequential depiction of a user positioned at the first position otherwise depicted in FIG. 29A wherein the user is looking downwardly in a forward direction to depict angled lines of eyesight relative to the generic walker tray.

FIG. 29C is a third sequential depiction and perspective view of the user looking downwardly toward the generic walker tray otherwise depicted in FIGS. 29A and 29B along the sight lines otherwise depicted in FIG. 29B showing a hidden object on the floor.

FIG. 30A is a first sequential depiction of a user positioned at a first position rearward of a generic walker apparatus outfitted with the first walker tray according to the presently disclosed subject matter wherein the user is looking in a forward direction.

FIG. 30B is a second sequential depiction of a user positioned at the first position otherwise depicted in FIG. 30A and looking downwardly in a forward direction to depict angled lines of eyesight relative to the first walker tray according to the presently disclosed subject matter.

FIG. 30C is a third sequential depiction and perspective view of the user looking downwardly toward the first walker tray otherwise depicted in FIGS. 30A and 30B along the sight lines otherwise depicted in FIG. 30B showing an object on the floor visible through the first walker tray.

FIG. 31 is a rearward perspective view of a generic walker apparatus with the first walker tray according to the presently disclosed subject matter installed thereupon with an optional utility bag installed on the first walker tray and generic walker apparatus.

FIG. 32 is a lateral perspective view of a generic walker apparatus with the first walker tray according to the presently disclosed subject matter installed thereupon with an optional utility bag installed on the first walker tray and generic walker apparatus.

FIG. 33 is a side perspective view of a fourth walker tray according to the presently disclosed subject matter showing a tray support portion of the fourth walker tray attached to forward legs of a walker apparatus and pivoted downwardly into a stowage configuration.

FIG. 34 is a side perspective view of the fourth walker tray according to the presently disclosed subject matter showing the tray support portion of the fourth walker tray attached to forward legs of a walker apparatus and pivoted upwardly into an object support configuration.

FIG. 35 is a top perspective view of the fourth walker tray according to the presently disclosed subject matter showing the tray support portion of the fourth walker tray attached to forward legs of a walker apparatus and pivoted upwardly into an object support configuration.

FIG. 36 is a side perspective view of the fourth walker tray according to the presently disclosed subject matter showing the tray support portion of the fourth walker tray attached to rearward legs of a fragmentary walker apparatus and pivoted downwardly into a stowage configuration.

### DETAILED DESCRIPTION OF THE EMBODIMENTS

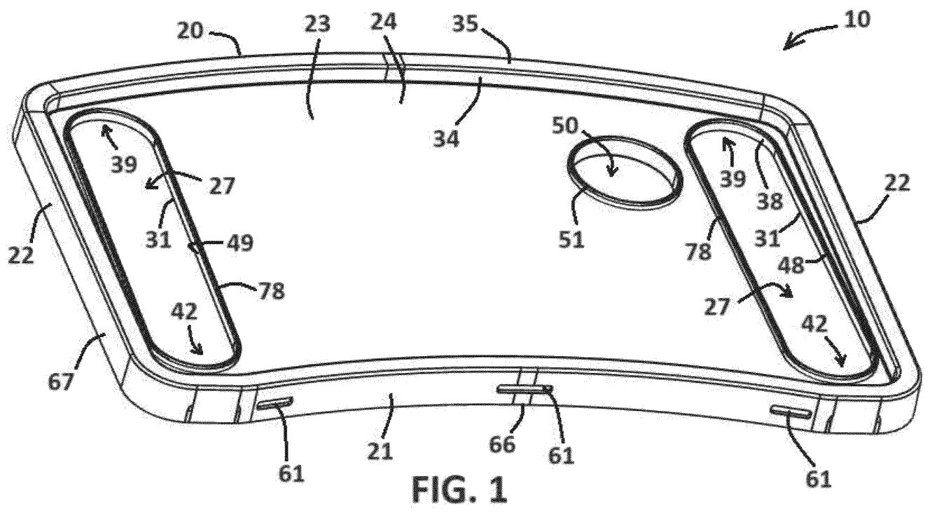

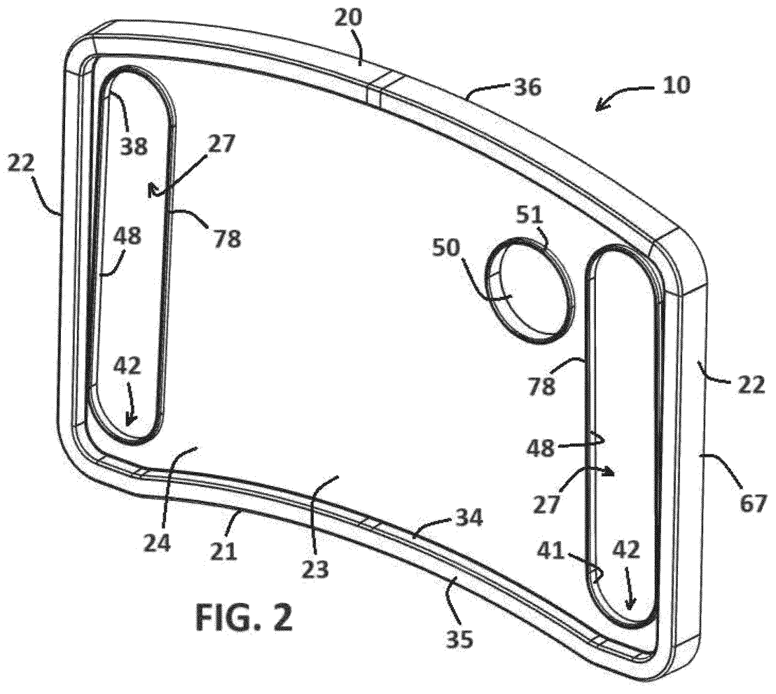

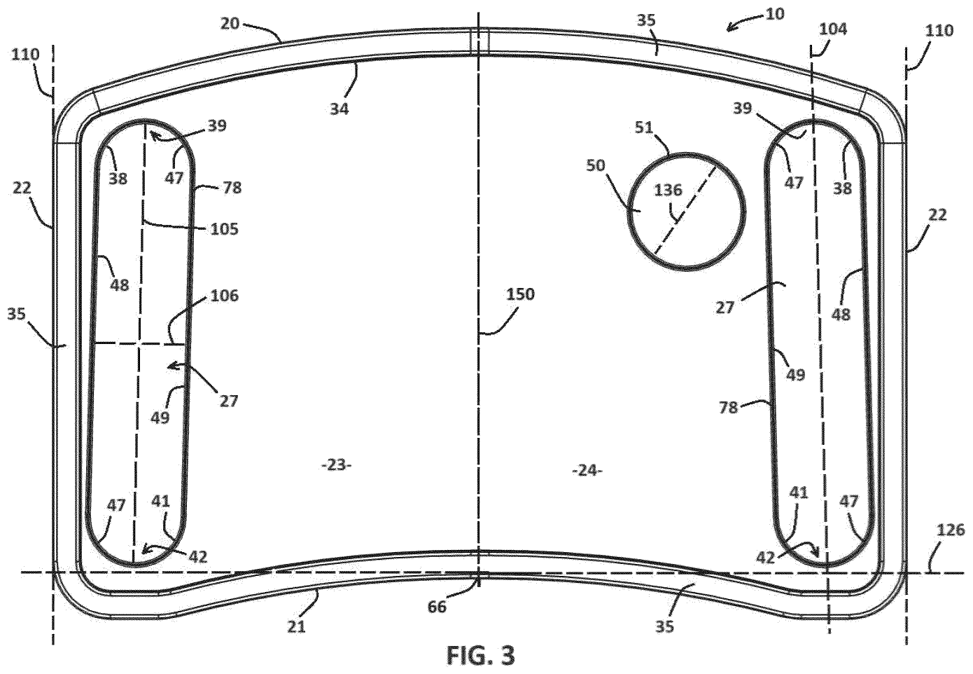

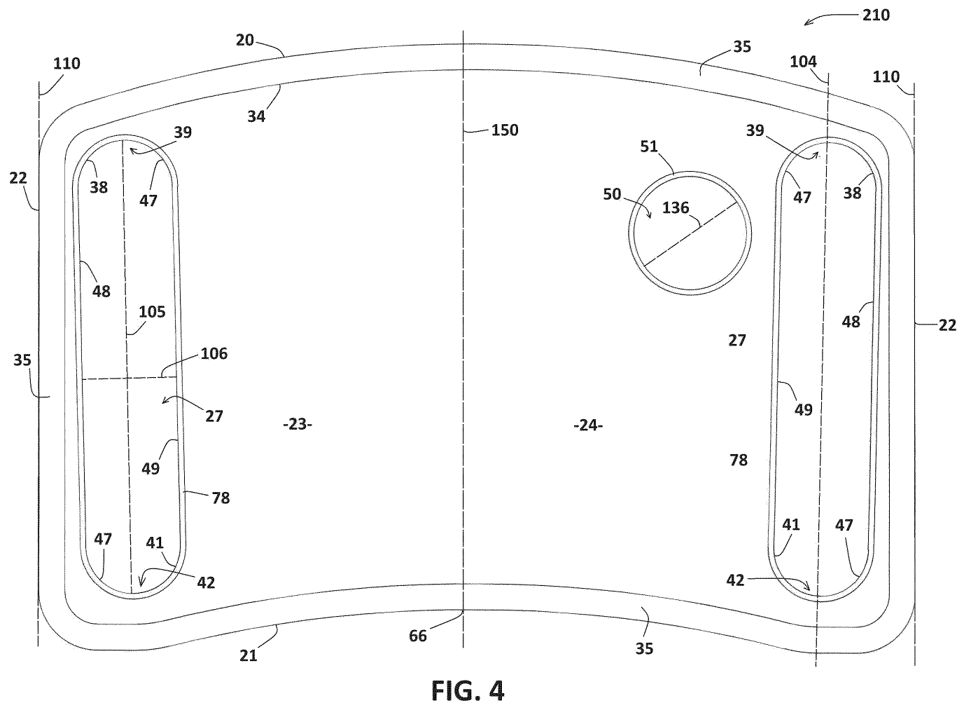

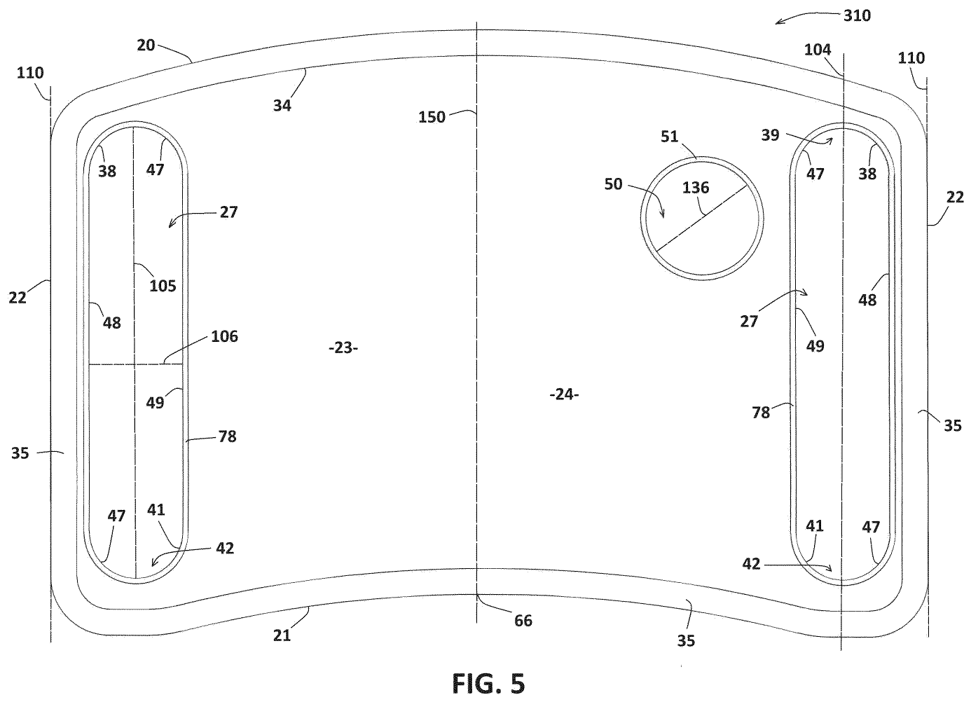

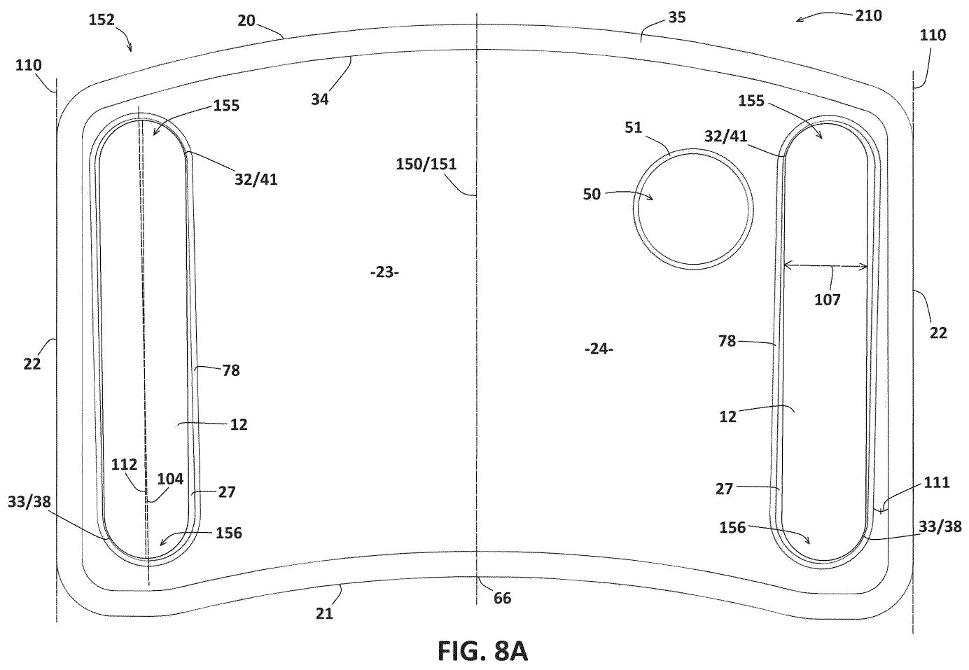

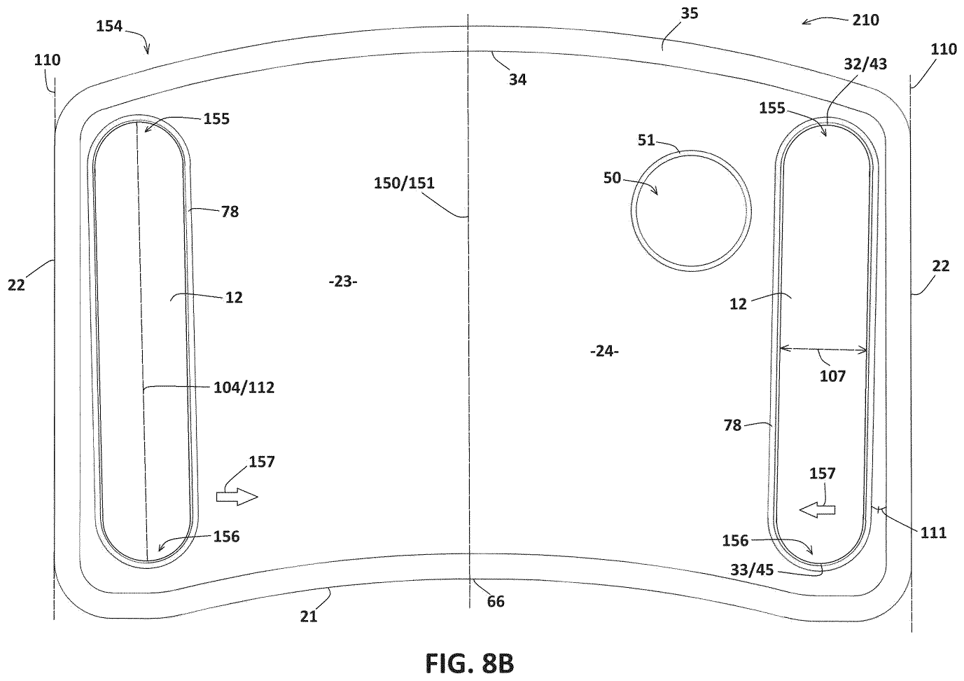

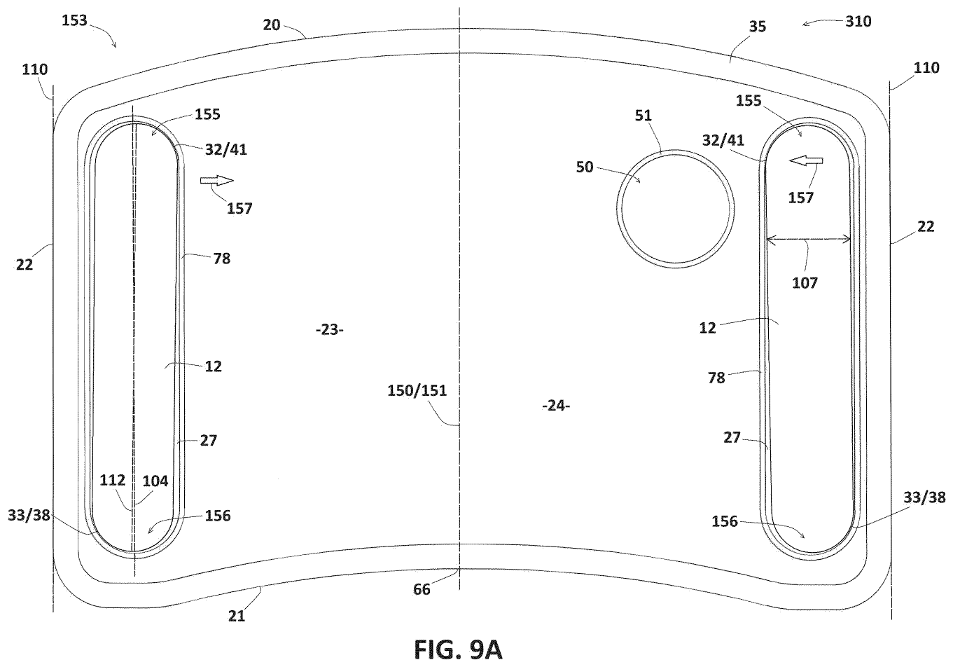

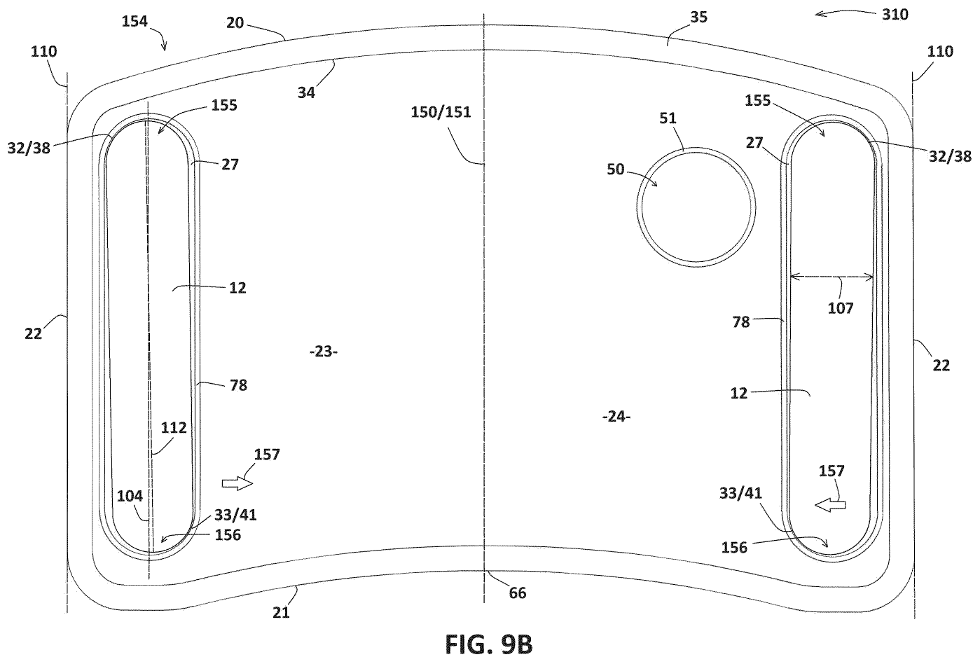

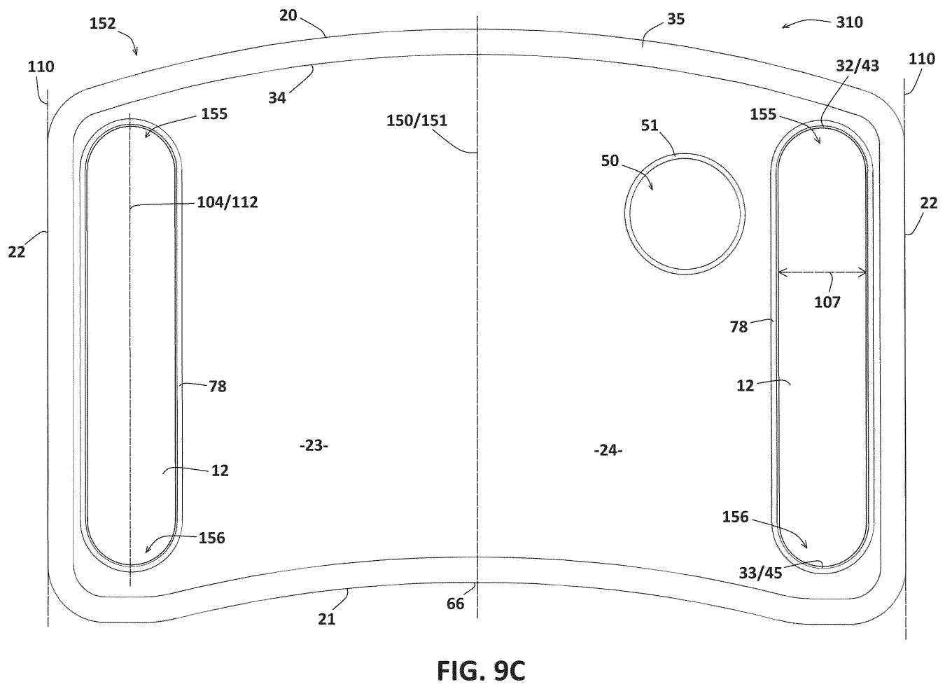

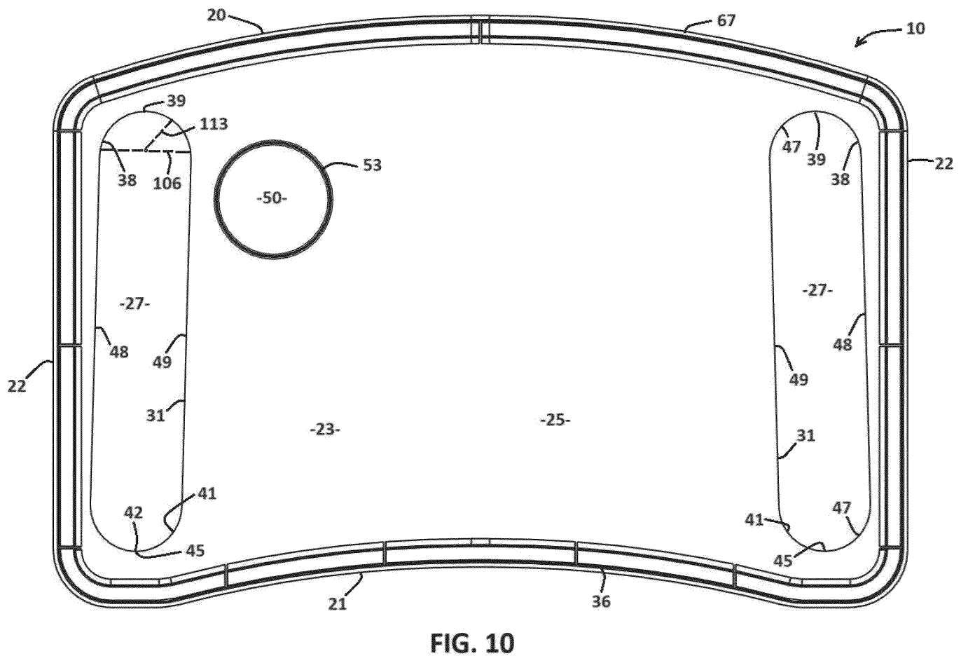

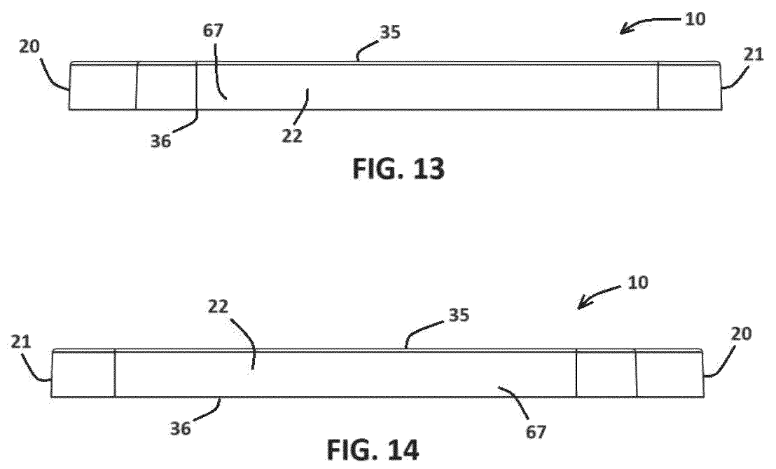

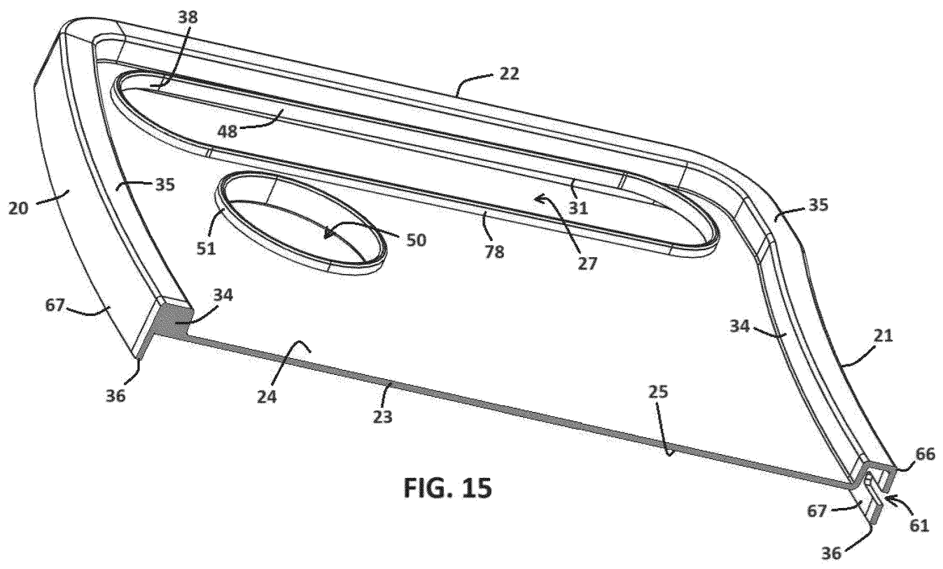

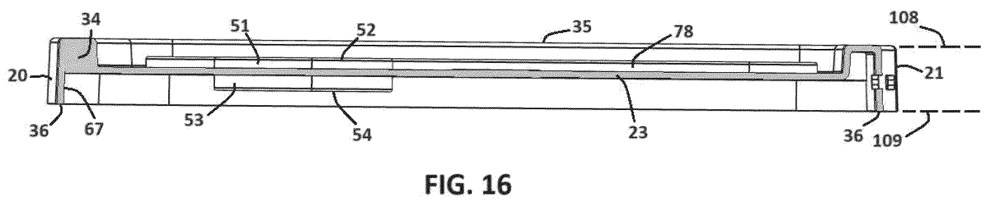

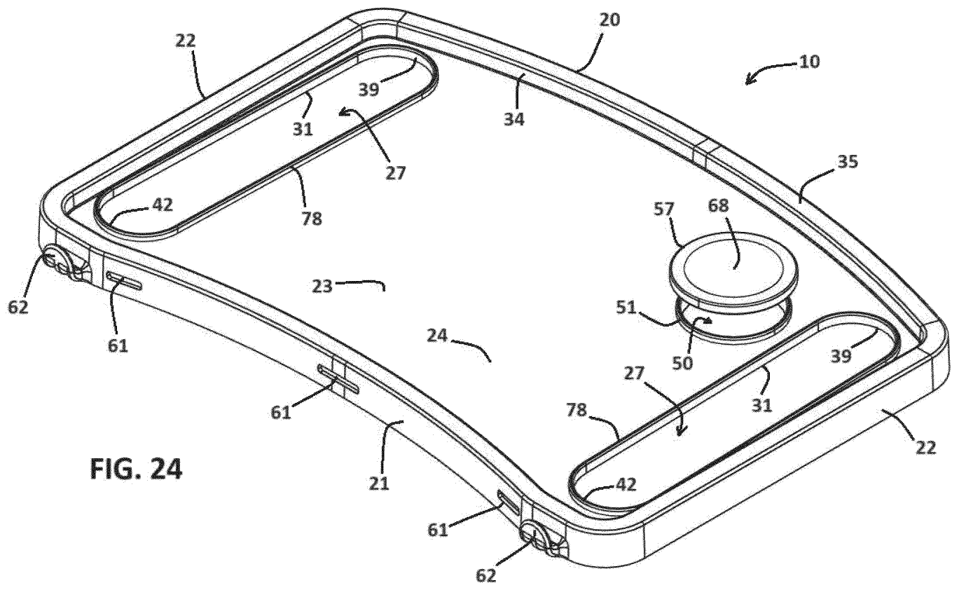

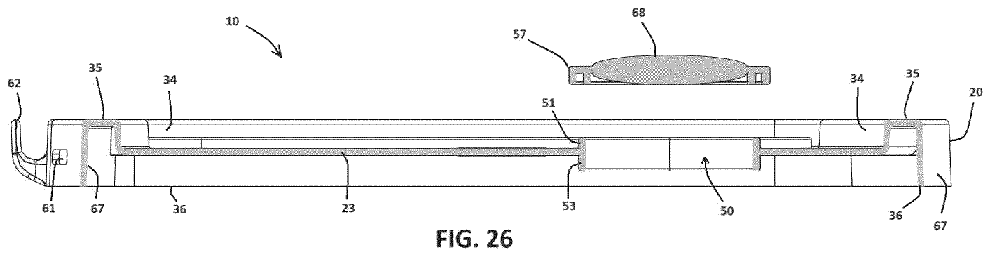

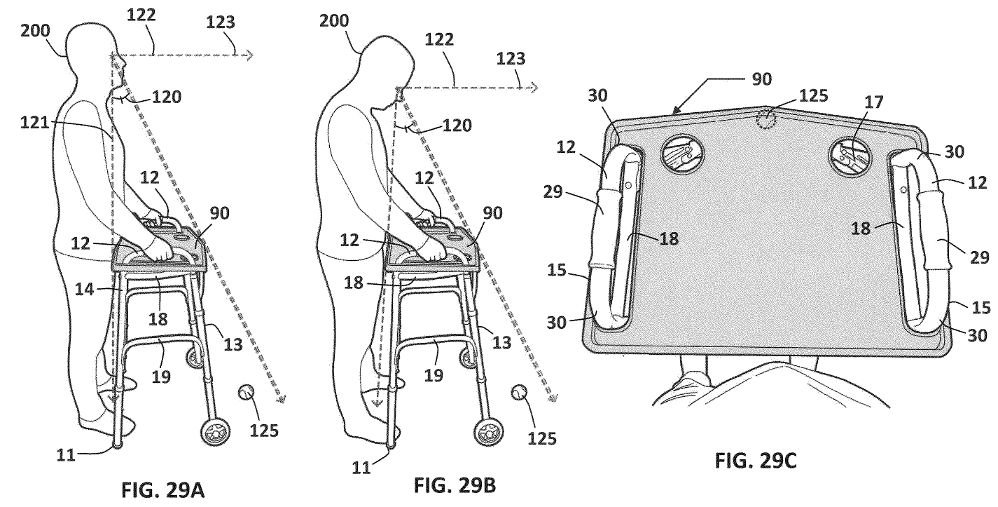

Referring now to the drawings with more specificity, the presently disclosed subject matter provides a number of apertured walker trays, including an apertured first walker tray as referenced at 10, an apertured second walker tray as referenced at 210, and an apertured third walker tray as referenced 310. The apertured first walker tray 10 is generally depicted and referenced in FIGS. 1-3, 7A, 7B, 10-14, 24-26, and 30A-32. The apertured second walker tray 210 is generally depicted and referenced in FIGS. 4, 8A and 8B. The apertured third walker tray 310 is generally depicted and referenced in FIGS. 5 and 9A-9C. The apertured first, second and third walker trays 10, 210 and 310 are substantially similar excepting for the configuration of opposed handle-letting apertures 27 extending through a tray support portion 23 relative to a medial tray axis 150 equidistant between laterally opposed sides 22 of the walker trays 10, 210 and 310. The medial tray axis 150 is referenced in FIGS. 3, 4, 5 and 7A through 9C. A conventional apertured walker tray is generally depicted and referenced at 90 in FIGS. 29A to 29C for comparison purposes.

A fourth walker tray according to the presently disclosed subject matter is generally depicted and referenced at 70 in FIGS. 32-36. The fourth walker tray 70 departs from the apertured arrangements of the apertured first, second and third walker trays 10, 210 and 310 and provides a differing tray-to-walker attachment mechanism. Whereas the opposed handle-letting apertures 27 of the apertured first, second and third walker trays 10, 210 and 310 function to mount the apertured first, second and third walker trays 10, 210 and 310 to a walker apparatus 11, the fourth walker tray 70 comprises mechanical fastening means for fastening the fourth walker tray 70 to a walker apparatus 11. The primary purpose of all walker trays 10, 210, 310, 70 and 90 is to provide the user 200 with a means to more safely support items such as a plate of food, drinks, books and other daily items. Should the user 200 wish to transport tray-supported items from one point to another, walker trays enable the user to grab handle portions 12 of an outfitted walker apparatus 11 and thereby further transport tray-supported items.

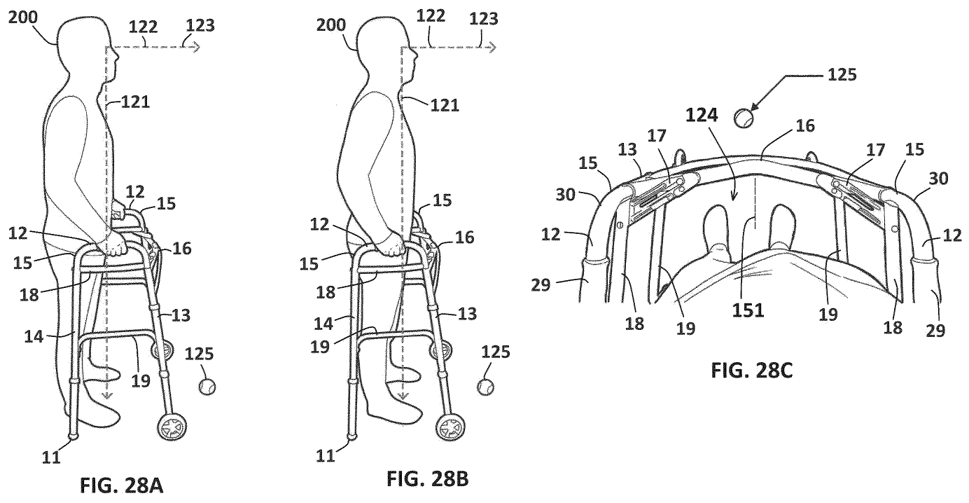

A user 200 who may lack the strength or confidence to be ambulatory without a walking aid is typically enabled to more confidently walk with the walker apparatus 11 surrounding their front and sides such that their hands and arms provide additional support by holding on to the top of the sides of the frame at handle portions 12 of the walker apparatus 11 as generally depicted in FIGS. 28A through 28C. FIGS. 28A through 28C depict a user 200 with a generic walker apparatus 11 without a walker tray installed. FIGS. 29A through 29C depict a user 200 with a generic walker apparatus 11 with a conventional apertured walker tray 90 installed. More particularly, FIG. 28A depicts a user 200 standing behind the walker apparatus 11 in a relative forward position along a forward direction 123 for enabling the user 200 to advance in the forward direction 123 with the support of the walker apparatus 11. FIG. 28B depicts a user 200 repositioned within the space 124 defined by the walker apparatus frame and facing the forward direction 123. With a more conventional apertured walker tray accessory 90 installed, the user 200 cannot use the walker apparatus 11 in its traditional and intended manner. Such conventional apertured walker trays 90, when installed, typically occupy the space 124 in which the user 200 would normally stand thereby forcing the user 200 to stand behind the walker apparatus 11 as generally and comparatively depicted in FIGS. 29A through 29C.

In other words, more conventional apertured walker trays 90 force the user 200 to position themselves outside the space 124 defined by the walker apparatus frame defined laterally by side support rails or upright leg arrangements 15 and in the forward direction 123 by a cross-member arrangement as at 16. The structural configuration of a conventional apertured walker tray 90 positions the user 200 well behind the walker apparatus 11, which firstly increases the forward and downward viewing angle 120 relative to the vertical plane 121 orthogonal to the horizontal plane 122 as generally and comparatively depicted in FIGS. 29A and 29B. Conventional apertured walker trays 90 are also formed from fully opaque materials thereby further reducing visibility and increasing the forward and downward viewing angle 120 relative to the vertical plane 121. This increased forward and downward viewing angle 120 reduces visibility and increases a user's risk of tripping and potentially falling due to this limited visibility. It will thus be understood conventional apertured walker trays 90 increase safety concerns for users 200.

It is further noted that many conventional apertured walker trays 90 have not been properly engineered to fit multiple styles and brands of walkers 11. Although at first glance many walkers 11 appear the same or similar, there are typically some slight differences in their physical design. One of these design differences stems from the configuration of the side support rails or upright leg arrangements 15 with upper handle portions 12. More particularly, the design differences stem from the overall width between the side support rails or upright leg arrangements 15, the depth from front to back of the walker frame, and the angle of the side support rails or upright leg arrangements 15 relative to the forward direction 123.

At least these design differences impact how a conventional apertured walker tray 90 will fit onto a walker apparatus 11 that best suits a user's abilities. Some users may prefer a certain angular configuration of laterally opposed upright leg arrangements 15 relative to a medial walker plane 151 as referenced in FIG. 28C. While one user may prefer a parallel arrangement of laterally opposed upright leg arrangements 15, another user may prefer an obliquely angled arrangement of laterally opposed upright leg arrangements 15. Further, this preference may change over time as the user becomes more or less ambulatory. The apertured, first, second and third walker trays 10, 210 and 310 according to the presently disclosed subject matter attempt to address this perceived need by providing a walker tray configured to reliably mount to at least two differing angled upright leg arrangements 15 of a walker apparatus 11.

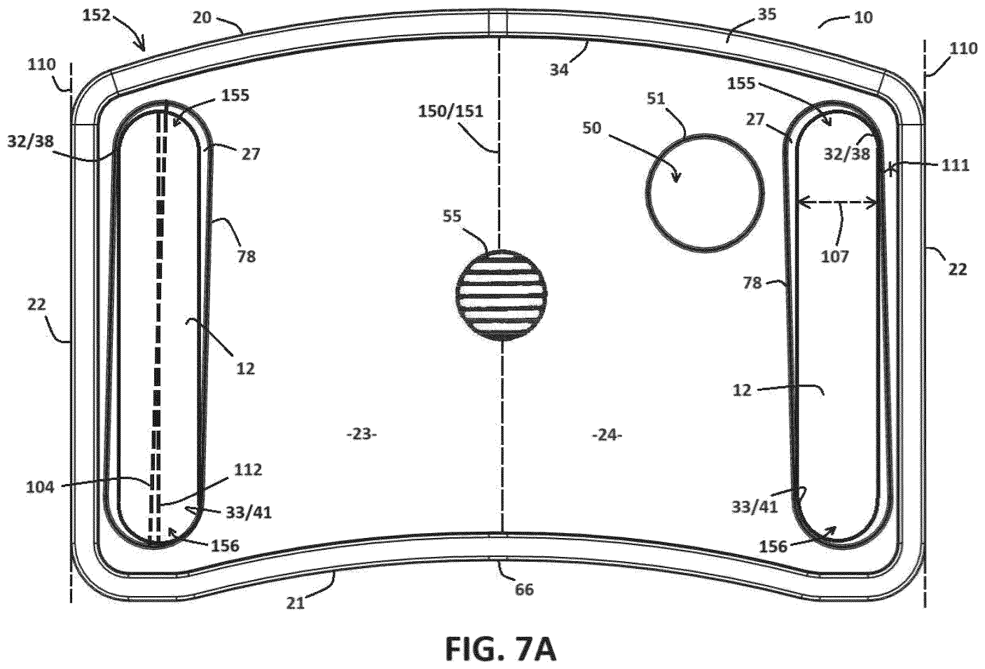

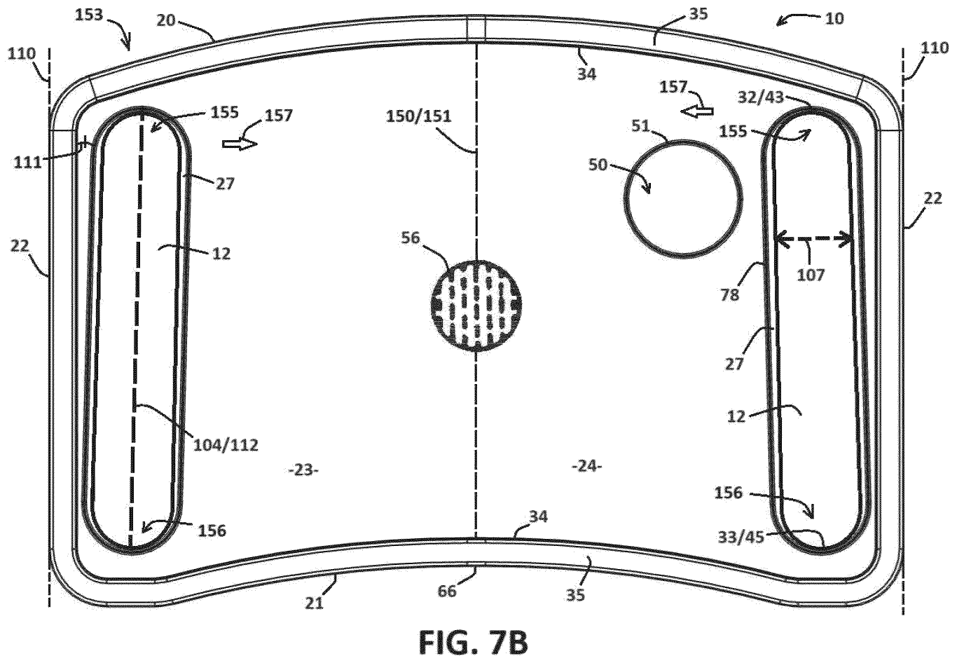

In other words, one user 200 may prefer a walker apparatus 11 having parallel upright leg arrangements 15 wherein the laterally opposed upright leg arrangements 15 extend parallel to the medial walker plane 151. Another user may prefer an obliquely angled leg arrangement wherein the laterally opposed upright leg arrangements 15 extend obliquely relative to the medial walker plane 151. In this last regard, some users 200 may prefer laterally opposed upright leg arrangements 15 obliquely angled relative to the medial walker plane 151 such that forward portions of the upright leg arrangements 15 are angled inwardly relative the medial walker plane 151 as at arrow 157 in FIGS. 7B and 9B while other users may prefer laterally opposed upright leg arrangements 15 obliquely angled relative to the medial walker plane 151 such that rearward portions of the upright leg arrangements 15 are angled inwardly relative the medial walker plane 151 as at arrow 157 in FIGS. 8B and 9B. In some embodiments, the apertured walker trays 10, 210 and 310 according to the presently disclosed subject matter enable a user 200 to mount the trays 10, 210 and 310 to at least two angular relationships of laterally opposed upright leg arrangements 15.

To overcome the perceived shortcomings of conventional apertured walker trays 90, the apertured first, second and third walker trays 10, 210 and 310 according to the presently disclosed subject matter are configured to further include an inwardly reduced radius on the rearward edge 21 opposite the user 200. The reduced radius allows the user 200 to stand relatively closer to the walker apparatus 11 toward or within the space 124 thereby positioning the user 200 closer to the walker frame for more proper or stable walker use and reducing the forward and downward viewing angle 120 while still providing the item-support convenience of the apertured first walker trays 10, 210 and 310.

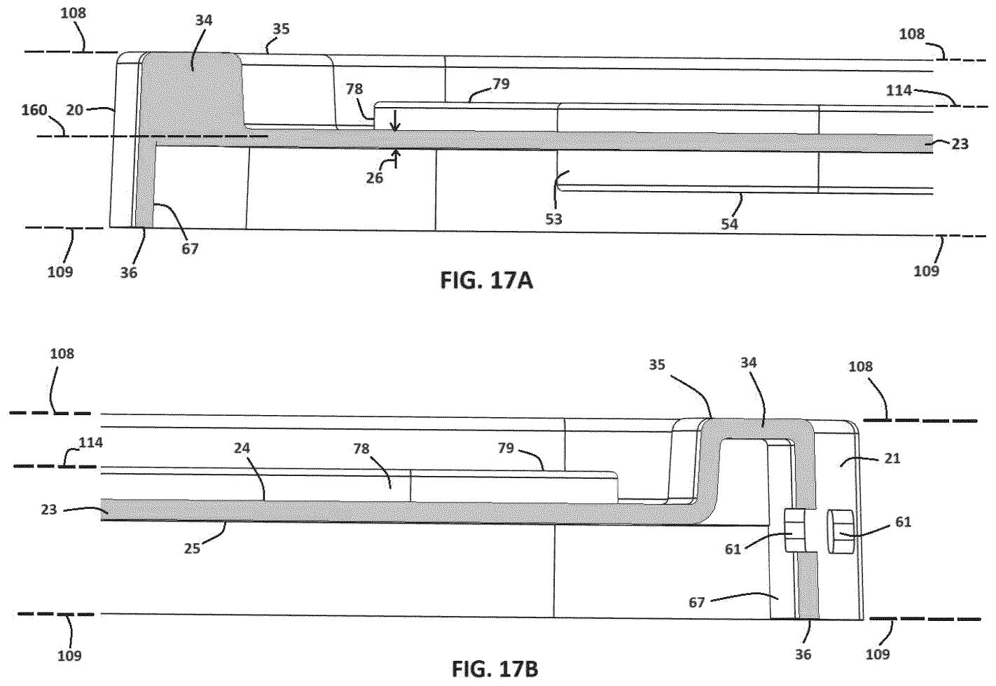

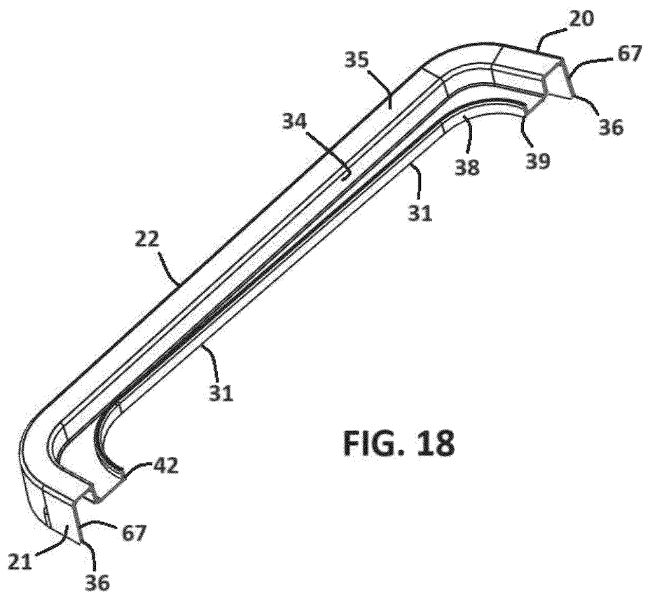

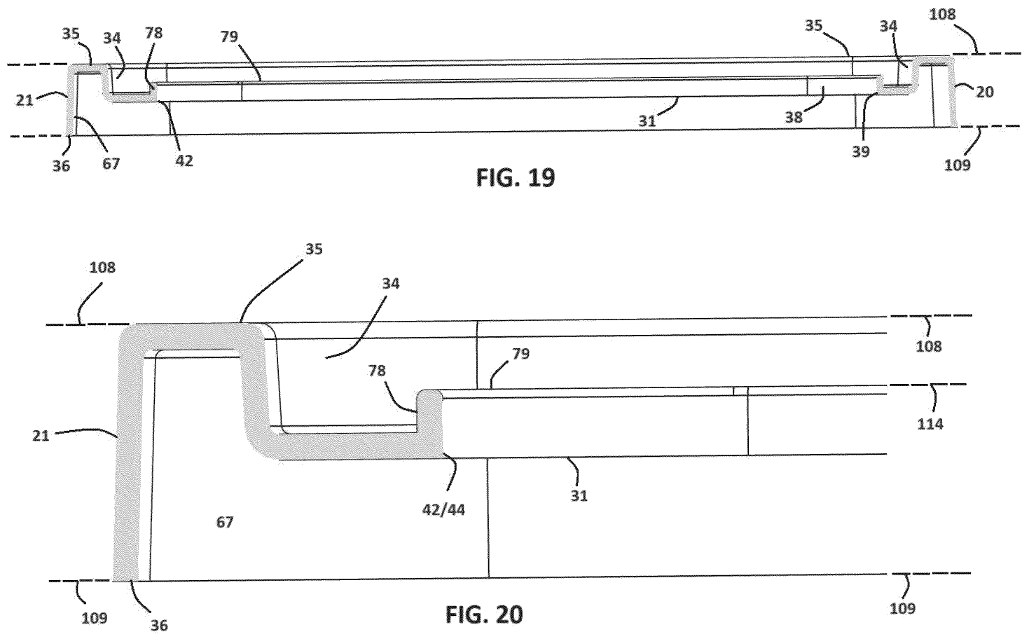

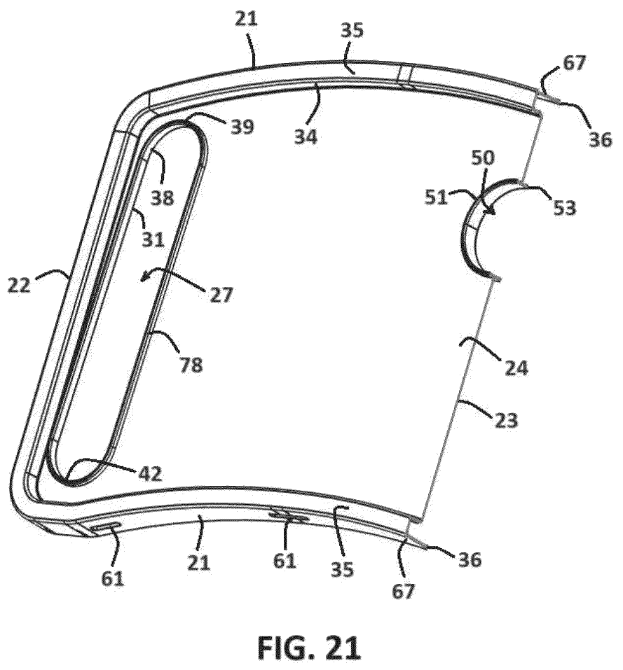

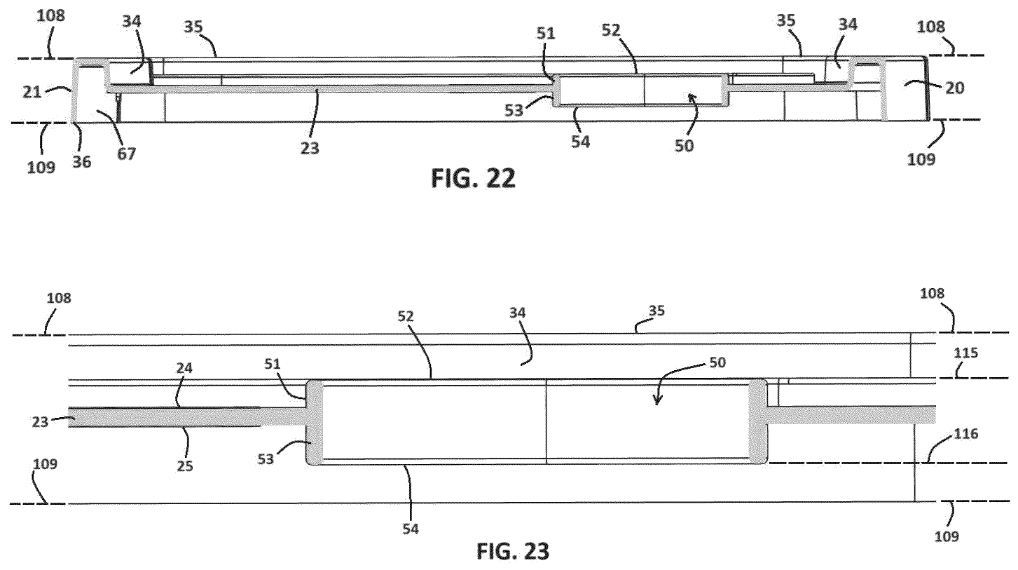

The apertured first, second and third walker trays 10, 210 and 310 are each designed to be mounted or installed upon a walker apparatus as variously depicted and referenced at 11. In some embodiments, the first, second and third walker trays 10, 210 and 310 each comprises a first tray-to-walker attachment mechanism configured to removably attach the walker trays 10, 210 and 310 to the walker apparatus 11 so as to position a tray support portion 23 thereof in a support plane 160 so as to provide a horizontal support surface for enabling a user to support items thereupon as referenced in FIG. 17A. More particularly, the first, second and third walker trays 10, 210 and 310 according to the presently disclosed subject matter are configured to removably seat down upon and be supported by the walker apparatus 11.

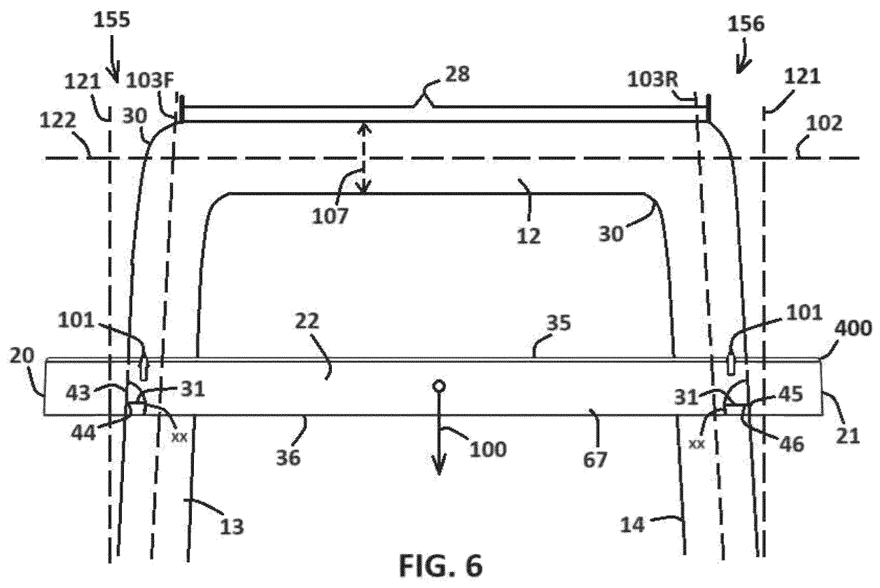

The weight 100 of the first, second and third walker trays 10, 210 and 310, generically referenced at 400 in FIG. 6, is directed downwardly such that portions of the walker apparatus 11 engage cooperative portions of the walker tray 400 configured to support the walker tray 400 during use thereof. Referencing FIG. 6, the reader will there see the weight is directed downwardly as at arrow 100 with weight-opposing support vectors being referenced at 101 originating from tray-to-walker engagement points described in more detail hereunder. Accordingly, in some embodiments, the first tray-to-walker attachment mechanism may be characterized by a pair of laterally opposed handle-receiving apertures 27 extending through the tray support portion 23 inwardly adjacent the laterally opposed edges 22 of the first, second and third walker trays 10, 210 and 310. The laterally opposed handle-receiving apertures 27 each extend along an aperture plane 104 intersecting the forward and rearward edges 20 and 21 of the walker trays 10, 210 and 310.

The walker apparatus 11 usable in combination with the walker trays 10, 210 and 310 according to the presently disclosed subject matter essentially comprises laterally opposable upper handle portions 12 each of which extend in a handle plane 102. In some embodiments, the handle planes 102 of each handle portion 12 are coplanar and substantially horizontal with the horizontal plane 122 as generally depicted in FIG. 6. In some embodiments, the handle plane(s) 102 are slightly obliquely angled relative to the horizontal as comparatively depicted in FIG. 32. Each handle portion 12 is supported within a respective handle plane 102 by way of a forward leg 13 and a rearward leg 14.

Accordingly, in certain applications, the walker apparatus 11 comprises two forward legs 13 and two rearward legs 14. Together the forward legs 13 and rearward legs 14 support the handle portions 12 within the handle planes 102. The walker apparatus 11 may also be said to comprise laterally opposed upright leg arrangements 15 each of which comprise from front to back: a forward leg 13, a handle portion 12, and a rearward leg 14 such that the handle portion 12 interconnects the forward leg 13 and the rearward leg 14 of each upright leg arrangement 15 at upper portions thereof.

In some embodiments, the walker trays 10, 210 and 310 according to the presently disclosed subject matter are designed to cooperate with a walker apparatus 11 generally formed from a tubular structural material as exemplified by tubular steel or aluminum having a generally uniform cross-sectional diameter as at 107 along the handle portions 12, the forward leg portions 13 and the rearward leg portions 14 particularly at the upper portions of the upright leg arrangements 15. In some embodiments, the forward legs 13 extend in a forward leg plane 103F and the rearward legs 14 extend in a rearward leg plane 103R, which leg planes 103F and 103R are angled relative to one another and a vertical plane as at 121 in FIG. 6.

In some embodiments, the leg planes 103F and 103R are obliquely angled relative to one another so as to be non-parallel and the walker trays 10, 210 and 310 are configured to cooperate with this particular structural configuration such that inner leg-engaging edge 31 portions of the handle-receiving apertures 27 of the walker trays 10, 210 and 310 engage outer surfacing of the obliquely angled forward and rearward leg portions 13 and 14. The outer surfacing of the forward and rearward leg portions 13 and 14 thereby provide opposed surfacing of wedge-like elements that together operate to wedge-support each of the walker trays 10, 210 and 310 upon the walker apparatus 11 as they respectively seat down and are installed upon upper portions of the laterally opposed upright leg arrangements 15 of the walker apparatus 11.

As illustrated in the drawing support accompanying this application, the walker apparatus 11 may, in some embodiments, comprises a cross-member arrangement 16 extending intermediate the forward legs 13, which forward legs 13 are pivotally attached to the cross-member arrangement 16 of each upright leg arrangement 15. Laterally opposed pivot limiter elements 17 are connected to the cross-member arrangement 16 and an upper crossbar 18 of each upright leg arrangement 15 in some embodiments. The upper crossbars 18 extend intermediate the forward leg 13 and the rearward leg 14 of each upright leg arrangement 15 in inferior adjacency to the handle portion 12 in substantially parallel relation thereto. Each upright leg arrangement 15 may further comprise a lower crossbar 19. The lower crossbars 19 extend intermediate the forward leg 13 and the rearward leg 14 of each upright leg arrangement 15 in inferior adjacency to the upper crossbar 18 in substantially parallel relation thereto.

In some embodiments, the upright leg arrangements 15 are pivotal about a pivot axis of rotation extending through the forward legs 13 at opposite ends of the cross-member arrangement 16. The upright leg arrangements 15 are pivotal so as to allow the user 200 to pivot the same about the pivot axes of rotation in a first rotational direction for configuring the walker apparatus into a first, usage state as generally depicted in FIGS. 28A through 32 and further about the pivot axes of rotation in a direction opposite the first direction for collapsing the walker apparatus 11 into a second, stowage or collapsed state (not specifically illustrated). In some applications, the user 200 may pivot the laterally opposed upright leg arrangements 15 into various angular configurations relative to one another including a parallel leg arrangement as at 152 in FIGS. 7A, 8A and 9C or either of two oblique leg arrangements as at inwardly angled leg arrangement 153 in FIGS. 7B and 9A or as at outwardly angled leg arrangement 154 in FIGS. 8B and 9B.

The walker trays 10, 210 and 310 according to the presently disclosed subject matter are each attachable to the walker apparatus 11 when in the first, usage state and removable therefrom before reconfiguring the walker apparatus 11 into the second, stowage or collapsed state. The walker trays 10, 210 and 310 are all further attachable to at least two upright leg arrangements as selected from the group consisting of the parallel leg arrangement 152, the inwardly angled leg arrangement 153 and the outwardly angled leg arrangement 154. The parallel leg arrangement 152 is characterized by laterally opposed upright leg arrangements 15 extending parallel to the medial walker plane 151; the inwardly angled leg arrangement 153 is characterized by laterally opposed upright leg arrangements 15 extending obliquely relative to the medial walker plane 151 such that forward portions155 of the upright leg arrangements 15 are inwardly angled as at arrow 157 relative to the medial walker plane 151; and the outwardly angled leg arrangement 154 is characterized by laterally opposed upright leg arrangements 15 extending obliquely relative to the medial walker plane 151 such that rearward portions 156 of the upright leg arrangements 15 are inwardly angled as at arrow 157 relative to the medial walker plane 151.

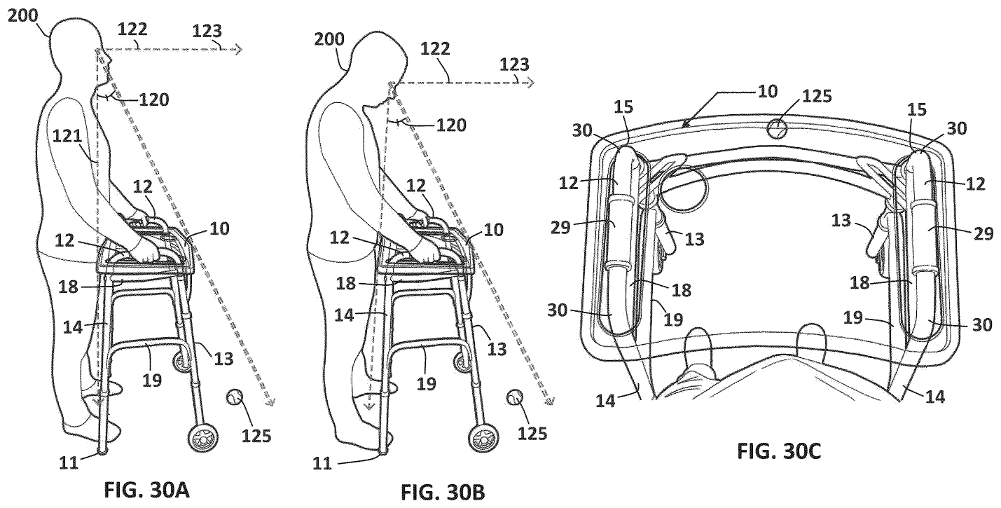

In some embodiments, the walker trays 10, 210 and 310 according to the presently disclosed subject matter comprise or are formed from a material suitable for injection-molding formation. In some embodiments, the material may be polycarbonate or acrylic. Such materials enable injection molding processes and provide a lightweight yet durable material construction. They may further provide light-transmittance through the walker trays 10, 210 and 310 and an ability to add a wide range of color tones to the material while maintaining light-transmittivity thereof for enabling a user 200 to see through at least a portion of the walker trays 10, 210 and 310 to see or visibly perceive objects thereunder as exemplified by a ball as at 125 in FIG. 30C.

While it is here noted that a preferred manufacturing process for the walker trays 10, 210 and 310 is by way of an injection-molding process, this should not be construed as limiting but rather exemplary. Other types of suitable manufacturing processes include, but are not limited to CNC machining, thermoset manufacturing, rotational molding, thermoforming, 3D printing, extrusion, and vacuum forming processes, the last of which is notably one of the most widely-used methods of thermoforming, a common alternative to injection molding.

As introduced above, the handle-receiving apertures 27 of the first, second and third walker trays 10, 210 and 310 are particularly configured to structurally cooperate with differing frame widths, depths and angles of side support rails or upright leg arrangements 15 of walker apparatuses 11 available on the market. The drawing support submitted in support of these specifications shows a certain offset angle 111 of the obliquely angled handle-receiving apertures 27 relative to the forward direction 123 or medial tray plane 150. The offset angle 111 is generally depicted in and referenced in connection with apertured first walker tray 10 in FIGS. 7A and 7B at the forward portions 39 of the handle-receiving apertures 27. The offset angle 111 is generally depicted and referenced in connection with walker tray 210 in FIGS. 8A and 8B at rearward portions 42 of the handle-receiving apertures 27. The offset angle 111 can be adjusted as needed to fit any brand of walker apparatus 11 as either currently offered or as provided by future offerings.

The handle-receiving apertures 27 of the respective trays 10, 210 and 310 are more particularly described below in connection with each of the first, second and third walker trays 10, 210 and 310 individually in turn. Those features that overlap or have correspondence between the trays 10, 210 and 310 have been particularly illustrated and are described in connection with the apertured first walker tray 10 for ease of illustration. The walker trays 10, 210 and 310 as formed from any suitable material each comprise a forward edge or side 20, a rearward edge or side 21, laterally opposed edges or sides 22, and a tray support portion 23 extending intermediate the forward edge 20, rearward edge 21, and laterally opposed edges 22.

In some embodiments, the forward edge 20 comprises a forward edge radius and the rearward edge 21 comprises a rearward edge radius. In some embodiments, the forward and rearward radii are convex relative to a user 200 positioned opposite the rearward edge 21. In some embodiments, the rearward edge radius is lesser than the forward edge radius and minimized so as to enable a user 200 to position oneself toward or within the space 124 defined by the upright leg arrangements 15 and the cross-member arrangement 16. In some embodiments, the rearward edge 21 comprises a midpoint 66 equidistant intermediate the laterally opposed edges 22, which midpoint 66 extends along or within a rearward plane 126 extending along rearward ends 42 of the handle-receiving apertures 27 as depicted and referenced in FIG. 3.

In some embodiments, at least one of the forward edge 20, the rearward edge 21, and the laterally opposed edges 22 comprises a hanger mechanism for enabling a user 200 to hang a utility bag as at 60 or other hangable items upon the first walker tray 10. In some embodiments, the hanger mechanism may be characterized by at least one of a strap-receiving aperture as at 61 and a loop supporting hook member as at 62. In other words, in some embodiments, the walker trays 10, 210 and 310 may each comprise or include integrally molded hook members 62. As illustrated, the hook members 62 are positioned along the rearward edge 21 adjacent the laterally opposed edges 22. However, the hook members 62 may be located on any of the forward, rearward or laterally opposed edges 20, 21, 22 of the walker trays 10, 210 and 310 according to the presently disclosed subject matter.

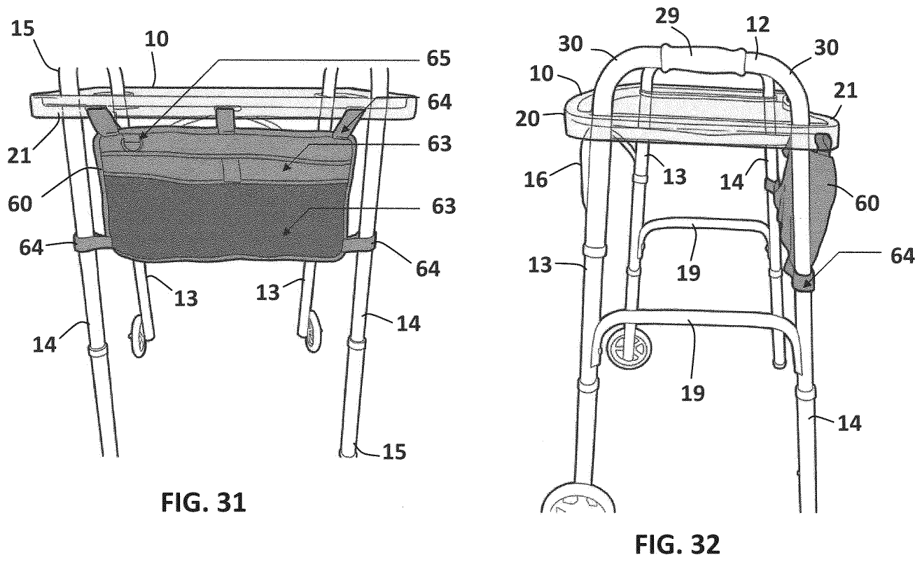

It is noted that many users 200 of walker apparatuses 11 are inclined to purchase an accessory or utility bag as at 60 that may be hung from the frame of the walker apparatus 11. Typically, these accessory or utility bags 60 are hung from one of the sides or the front of the frame. This mounting location requires the user 200, once seated, to move the walker apparatus 11 to gain access to the bag 60. This can be difficult for some users 200 who lack upper body strength. By adding an accessory mounting hanger mechanism as exemplified by strap-receiving apertures 61 or hook members 62 on the rearward edge 21 opposite the user 200, the bag 60 may face the user 200 once seated and does not require the user to manipulate the walker apparatus 11 to gain access to the storage pockets as at 63. Straps 64 of the utility bag 60 may be inserted through the strap-receiving apertures 61 and around the rearward legs 14 to hang the utility bag 60 from the walker trays 10, 210 and 310 and attach the same to the walker apparatus 11. The utility bag 60 may further comprise other attachment mechanisms such as a loop member as at 65 in FIG. 31.

Central to the practice of the invention is the tray support portion 23, which extends intermediate the forward edge 20, the rearward edge 21 and the laterally opposed edges 22 and is configured to support objects placed thereupon (not specifically illustrated). The tray support portion 23 comprises an upper tray surface 24 and a lower tray surface 25 with a substantially uniform tray support thickness 26 extending therebetween. In some embodiments, the tray support portion 23 is substantially planar with a substantially uniform tray thickness 26 within a thickness range of 3 to 5 millimeters. In some embodiments, at least the tray support portion 23 is formed from a light-transmissive material for allowing light to pass therethrough and for enabling a user 200 to see through at least the tray support portion 23 as described hereinabove. Together the uniform tray thickness 26 and the light-transmissive material provide a preferred item support function and preferred light-transmittance based on properties of the material used in the formation thereof.

In some embodiments, the walker trays 10, 210 and 310 may be formed by way of an injection molding process and accordingly, in some embodiments, the entirety of the walker trays 10, 210 and 310 may be formed from a light-transmissive material for allowing light to pass therethrough, including the forward edge 20, the rearward edge 21, the laterally opposed edges 22, and the tray support portion 23. In some embodiments, at least the tray support portion 23 is formed from a colored light-transmissive material for coloring and altering a light-transmittance thereof. In some embodiments, for example, the colored light-transmissive material may be of blue coloration as depicted at hatch marking 55 in FIG. 7A, and in some embodiments the colored light-transmissive material may be of purple coloration as depicted at hatch marking 56 in FIG. 7B.

In this last regard, it is noted the visible spectrum is the band of the electromagnetic spectrum that is visible to the human eye. Electromagnetic radiation within this range of wavelengths is called visible light or more simply “light”. A typical human eye will respond to wavelengths from about 380 nanometers (at the ultraviolet end of the spectrum) to about 750 nanometers at (the infrared end of the spectrum). As earlier stated, one possible material for the walker tray is polycarbonate, which exhibits roughly 85% to 90% transmission of visible light within the visible spectrum. Another possible material for the walker trays 10, 210 and 310 is acrylic, which exhibits roughly 92% transmission of visible light within the visible spectrum.

Accordingly, in some embodiments, the walker trays 10, 210 and 310 and at least the tray support portion 23 may be said to exhibit light transmittance within this range and thus may be said to provide a translucent walker tray or at least a translucent tray support portion 23 for enabling users 200 to see therethrough while simultaneously providing some limited degree of non-transparency or opacity so that users 200 are able to visibly discern the structure of the walker trays 10, 210 and 310. While other materials may be used in the formation of the walker trays 10, 210 and 310, a central aspect of the presently disclosed subject matter is to provide a tray support portion 23 that provides translucency for enabling a user 200 to see through at least a portion of the walker trays 10, 210 and 310 for improving overall safety of use of a walker apparatus 11 with the walker trays 10, 210 and 310 as installed thereupon.

The walker trays 10, 210 and 310 according to the presently disclosed subject matter each further comprise a pair of laterally opposed handle-receiving apertures 27 extending through the tray support portion 23 inwardly adjacent the laterally opposed edges 22 each of which extend along an aperture plane 104 intersecting the forward and rearward edges 20 and 21. Each of the handle-receiving apertures 27 has an aperture length 105 extending along the aperture planes 104 and an aperture width 106 extending orthogonally relative to the aperture planes 104. In some embodiments, the aperture lengths 105 of the respective handle-receiving apertures 27 are of a uniform dimension, and in some embodiments, the respective aperture widths 106 of each handle-receiving aperture 27 are of a uniform dimension or the same.

The aperture lengths 105 are greater than a handle portion length 28 of each handle portion 12 and the aperture widths 106 are greater than the cross-sectional diameter as at 107 of the handle portions 12. In some embodiments, the handle portions 12 may be outfitted with a hand grip as at 29 in FIGS. 28C, 29C, 30C and 31. The aperture widths 106 are also greater than a width of the hand grips 29. The aperture lengths 105 and aperture widths 106 are thus configured to receive at least the upper handle portions 12 through the handle-receiving apertures 27. In some embodiments, the forward legs 13 and rearward legs 14 are coextensive with the handle portions 12 of each upright leg arrangement 15. In some embodiments, radiused portions 30 extend from opposed ends of the handle portion 12 intermediate upper portions of the forward leg 13 and rearward leg 14 of each upright leg arrangement 15.

Each of the handle-receiving apertures 27 are defined inwardly by an inner leg-engaging edge 31 configured to engage at least a forward leg portion 32 of each of the forward legs 13 and a rearward leg portion 33 of each of the rearward legs 14. The handle portions 12 and radiused portions 30 are receivable in and through the handle-receiving apertures 27 and the walker trays 10, 210 and 310 may be directed downwardly along the upper portions of the forward and rearward legs 13 and 14 until the inner leg-engaging edge 31 engages at least a forward leg portion 32 and a rearward leg portion 33.

It will be recalled the forward legs 13 are angled relative to the rearward legs 14 and as the walker trays 10, 210 and 310 travel downwardly along the length of the forward and rearward legs 13 and 14, the trays 10, 210 and 310 reach a point where the inner leg-engaging edge 31 engages at least a forward leg portion 32 and a rearward leg portion 33 such that the forward and rearward leg portions 32 and 33 engage the inner leg-engaging edge 31 for wedge-supporting the walker trays 10, 210 and 310 upon the walker apparatus 11 in some embodiments. The weight-opposing support vectors referenced at 101 originate from tray-to-walker engagement points characterized by contact between the forward and rearward leg portions 32 and 33 and the inner leg-engaging edge 31 as generally depicted and referenced in FIG. 6 at “xx”.

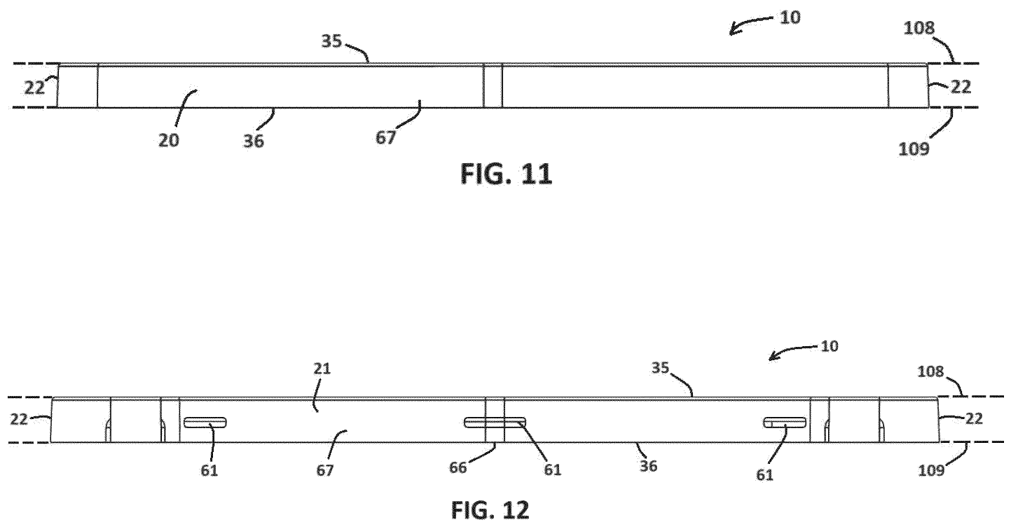

In some embodiments, the walker trays 10, 210 and 310 according to the presently disclosed subject matter each further comprise an upper peripheral edge ridge formation 34 extending along the forward edge 20, the rearward edge 21, and laterally opposed edges 22 such that an upper edge portion 35 of the upper peripheral edge ridge formation 34 extends in an upper edge plane 108 in parallel relation to the upper tray surface 24 as referenced in FIGS. 11 and 12. In some embodiments, the walker trays 10, 210 and 310 each further comprise a bottom edge 36 extending in a bottom edge plane 109 parallel to the upper ridge plane 108, the upper tray surface 24, and the lower tray surface 25 as further referenced in FIGS. 11 and 12. In other words, the tray support portion 23 extends intermediate the upper peripheral edge ridge formation 34, which terminates upwardly at the upper edge portion 35. The forward edge 20, the rearward edge 21, and laterally opposed edges 22 terminate downwardly at the bottom edge 36, which extends in the bottom edge plane 109 in spaced relation to the bottom tray surface 25 thereby providing a downwardly extending outer tray skirt 67 at the forward edge 20, the rearward edge 21, and the laterally opposed edges 22.

In some embodiments, the laterally opposed edges 22 of the walker trays 10, 210 and 310 are parallel to one another extending along edge planes 110 extending at least in the forward direction 123 in parallel to the medial tray plane 150 as generally depicted and referenced in FIGS. 3-5 and 7A-9C. In some embodiments, the aperture planes 104 of the apertured first walker tray 10 and the apertured second walker tray 210 are obliquely angled relative the laterally opposed edges 22 and edge planes 110 as further generally depicted in FIGS. 3, 4, and 7A through 8B. In some embodiments, the offset angle 111 intermediate the aperture planes 104 and the edge planes 110 is within an angle range of 1 to 5 degrees. In some embodiments, the offset angle 111 is within a range of 2.5 to 3 degrees.

The offset angle 111 helps support a universal fit for a variety of walkers or walker apparatuses 11 as some walker apparatuses 11 provide upright leg arrangements 15 that are parallel to one another as generally depicted and referenced at parallel leg arrangement 152 in FIGS. 7A, 8A and 9C, whereas other walker apparatuses 11 provide or comprise upright leg arrangements 15 that are obliquely angled to one another, particularly when directed into the first, usage state. It will be recalled the inwardly angled leg arrangement 153 is depicted and referenced in FIGS. 7B and 9A and the outwardly angled leg arrangement 154 is depicted and referenced in FIGS. 8B and 9B.

The handle-receiving apertures 27 of the first walker tray 10 are configured so as to support the first walker tray 10 upon a walker apparatus 11 having at least (a) parallel laterally opposed upright leg arrangements 15 with handle portions 12 or a parallel leg arrangement 152 as depicted in FIG. 7A or (b) angled laterally opposed leg arrangements 15 as exemplified by inwardly angled leg arrangement 153 with handle portions 12 as depicted in FIG. 7B. Referencing FIG. 7A, the reader will there consider a walker apparatus 11 having parallel upright leg arrangements 15 with handle portions 12 in which the arrangement planes 112 are obliquely angled relative to the aperture planes 104 when the first walker tray 10 is mounted upon the walker apparatus 11.

Outer upper portions of the forward legs 13 engage outer portions 38 of the handle-receiving apertures 27 at forward ends 39 along the inner leg-engaging edge 31 while outer upper portions of the rearward legs 14 engage inner portions 41 of the handle-receiving apertures 27 at rearward ends 42 along the inner leg-engaging edge 31. The forward leg portions 32 correspond to the outer upper portions of the forward legs 13 and the rearward leg portions 33 correspond to the inner upper portions of the rearward legs 14 in this application.

Comparatively referencing FIGS. 6 and 7B, the reader will there consider a walker apparatus 11 having obliquely angled upright leg arrangements 15 with handle portions 12 in which the arrangement planes 112 are aligned with the aperture planes 104 when the first walker tray 10 is mounted upon the walker apparatus 11. In this application, forward upper portions 43 of the forward legs 13 engage forward portions 44 of the handle-receiving apertures 27 at forward ends 39 thereof along the inner leg-engaging edge 31 while rearward upper portions 45 of the rearward legs 14 engage rearward portions 46 of the handle-receiving apertures 27 at rearward ends 42 thereof along the inner leg-engaging edge 31. The forward leg portions 32 correspond to the forward upper portions 43 of the forward legs 13 and the rearward leg portions 33 correspond to the rearward upper portions 45 of the rearward legs 14 in this application.

The handle-receiving apertures 27 of the second walker tray 210 are configured so as to support the second walker tray 10 upon a walker apparatus 11 having at least (a) parallel laterally opposed upright leg arrangements 15 with handle portions 12 or a parallel leg arrangement 152 as depicted in FIG. 8A or (b) obliquely angled laterally opposed leg arrangements 15 as exemplified by outwardly angled leg arrangement 154 with handle portions 12 as depicted in FIG. 8B. Referencing FIG. 8A, the reader will there consider a walker apparatus 11 having parallel upright leg arrangements 15 with handle portions 12 in which the arrangement planes 112 are obliquely angled relative to the aperture planes 104 when the second walker tray 20 is mounted upon the walker apparatus 11.

Inner upper portions of the forward legs 13 engage inner portions 41 of the handle-receiving apertures 27 at forward ends 39 along the inner leg-engaging edge 31 while outer upper portions of the rearward legs 14 engage outer portions 38 of the handle-receiving apertures 27 at rearward ends 42 along the inner leg-engaging edge 31. The forward leg portions 32 correspond to the inner upper portions of the forward legs 13 and the rearward leg portions 33 correspond to the outer upper portions of the rearward legs 14 in this application.

Comparatively referencing FIGS. 6 and 8B, the reader will there consider a walker apparatus 11 having obliquely angled upright leg arrangements 15 with handle portions 12 in which the arrangement planes 112 are aligned with the aperture planes 104 when the second walker tray 210 is mounted upon the walker apparatus 11. In this application, forward upper portions 43 of the forward legs 13 engage forward portions 44 of the handle-receiving apertures 27 at forward ends 39 thereof along the inner leg-engaging edge 31 while rearward upper portions 45 of the rearward legs 14 engage rearward portions 46 of the handle-receiving apertures 27 at rearward ends 42 thereof along the inner leg-engaging edge 31. The forward leg portions 32 correspond to the forward upper portions 43 of the forward legs 13 and the rearward leg portions 33 correspond to the rearward upper portions 45 of the rearward legs 14 in this application.

The handle-receiving apertures 27 of the third walker tray 310 are configured so as to support the third walker tray 10 upon a walker apparatus 11 having at least (a) parallel laterally opposed upright leg arrangements 15 with handle portions 12 or a parallel leg arrangement 152 as depicted in FIG. 9C or (b) obliquely angled laterally opposed leg arrangements 15. Both the inwardly angled leg arrangement 153 and the outwardly angled leg arrangement 154 are depicted in connection with third walker tray 310. The inwardly angled leg arrangement 153 is depicted in FIG. 9A and the outwardly angled leg arrangement 154 is depicted in FIG. 9B.

Referencing FIG. 9A, the reader will there consider a walker apparatus 11 having inwardly angled leg arrangement 153 with handle portions 12 in which the arrangement planes 112 are obliquely angled relative to the aperture planes 104 when the third walker tray 310 is mounted upon the walker apparatus 11. Inner upper portions of the forward legs 13 engage inner portions 41 of the handle-receiving apertures 27 at forward ends 39 along the inner leg-engaging edge 31 while outer upper portions of the rearward legs 14 engage outer portions 38 of the handle-receiving apertures 27 at rearward ends 42 along the inner leg-engaging edge 31. The forward leg portions 32 correspond to the outer upper portions of the forward legs 13 and the rearward leg portions 33 correspond to the inner upper portions of the rearward legs 14 in this application.

Comparatively referencing FIG. 9B, the reader will there consider a walker apparatus 11 having outwardly angled leg arrangement 154 with handle portions 12 in which the arrangement planes 112 are obliquely angled relative to the aperture planes 104 when the third walker tray 310 is mounted upon the walker apparatus 11. Outer upper portions of the forward legs 13 engage outer portions 38 of the handle-receiving apertures 27 at forward ends 39 along the inner leg-engaging edge 31 while inner upper portions of the rearward legs 14 engage inner portions 41 of the handle-receiving apertures 27 at rearward ends 42 along the inner leg-engaging edge 31. The forward leg portions 32 correspond to the outer upper portions of the forward legs 13 and the rearward leg portions 33 correspond to the inner upper portions of the rearward legs 14 in this application.

The reader will note the handle-receiving apertures 27 are configured to be matable with at least two type of upright leg arrangements 15, including parallel leg arrangement 152 and either or both the inwardly and outwardly angled leg arrangements 153/154. To provide this feature, in some embodiments, each handle-receiving aperture 27 of the walker trays 10, 210 and 310 comprises a semicircular or radiused portion 47 inwardly adjacent the forward edge 20 and the rearward edge 21 wherein each semicircular or radiused portion 47 has a uniform radius 113 from an outer aperture side 48 to an inner aperture side 49 parallel to the outer aperture side 48 of the handle-receiving aperture 27. In some embodiments, the radiused portions 47 convexly extend intermediate the aperture width 106 relative to one another at the forward end 39 and the rearward end 42. In some embodiments, the uniform radius 113 is within a radius range of 25 millimeters to 38 millimeters and the corresponding aperture width 106 is within a width range of 50 millimeters to 76 millimeters.

In some embodiments, the uniform radius 113 is within a range of 31 millimeters to 32 millimeters and the corresponding aperture width 106 is within a width range of 62 millimeters to 64 millimeters. The cross-sectional diameter 107 of the tubular body of each handle portion 12 is lesser than these dimensions and thus the handle-receiving apertures 27 are able to receive the handle portions 12 widthwise or across the aperture widths 106. In some embodiments, the aperture length 105 extending intermediate the forward end 39 and the rearward end 42 of each handle-receiving aperture 27 is within a length range of 300 millimeters to 310 millimeters and in some embodiments, the aperture length 105 extending intermediate the forward end 39 and the rearward end 42 of each handle-receiving aperture 27 is within a length range of 304 millimeters to 306 millimeters.

In some embodiments, each handle-receiving aperture 27 comprises a peripheral aperture ridge formation 78 such that a first upper ridge portion 79 of the upper peripheral aperture ridge formation 78 extends in a first upper ridge plane 114 intermediate the upper tray surface 24 and the upper edge plane 108 in parallel relation thereto as generally depicted in FIGS. 17A and 17B. In some embodiments, the walker trays 10, 210 and 310 each further comprises at least a third aperture 50 extending through the upper and lower tray surfaces 24 and 25 of the tray support portion 23. In some embodiments, the third aperture 50 is circular in form and comprises an aperture diameter as at 136 in FIGS. 3-5. In some embodiments, the aperture diameter 136 is on the order of 75 to 80 millimeters.

In some embodiments, the third aperture 50 comprises an upper peripheral aperture ridge formation 51 such that an upper ridge portion 52 of the upper peripheral aperture ridge formation 51 extends in a second upper ridge plane 115 intermediate the upper tray surface 24 and the upper edge plane 108 in parallel relation thereto. In some embodiments, the first and second upper ridge planes114 and 115 are coplanar. In some embodiments, the third aperture 50 comprises a lower peripheral aperture ridge formation 53 such that a lower ridge portion 54 of the lower peripheral aperture ridge formation 53 extends in a lower ridge plane 116 intermediate the lower tray surface 25 and the bottom edge plane 109 in parallel relation thereto.

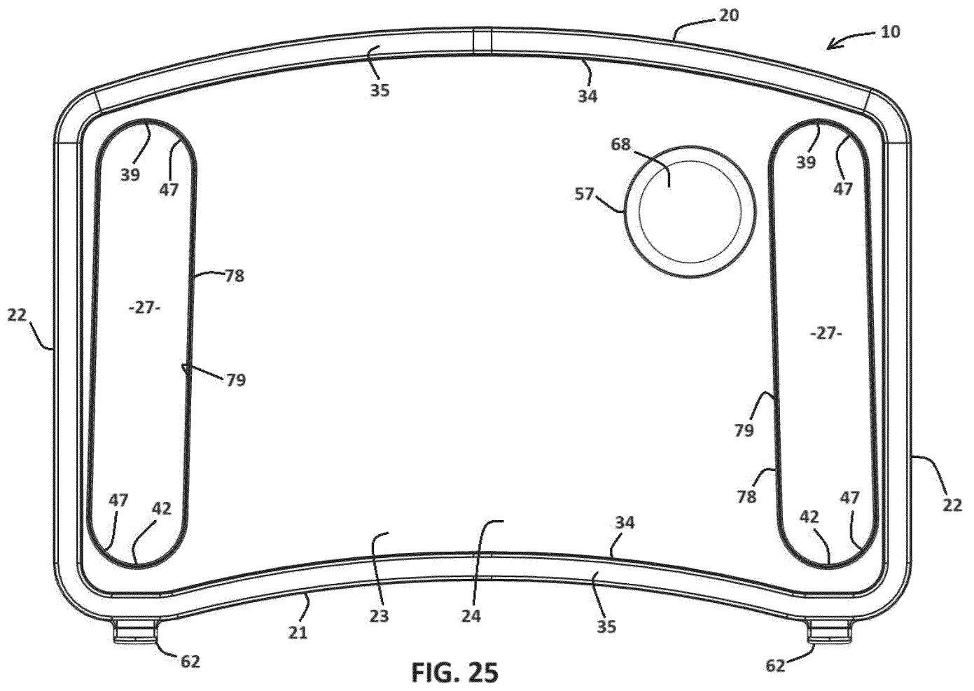

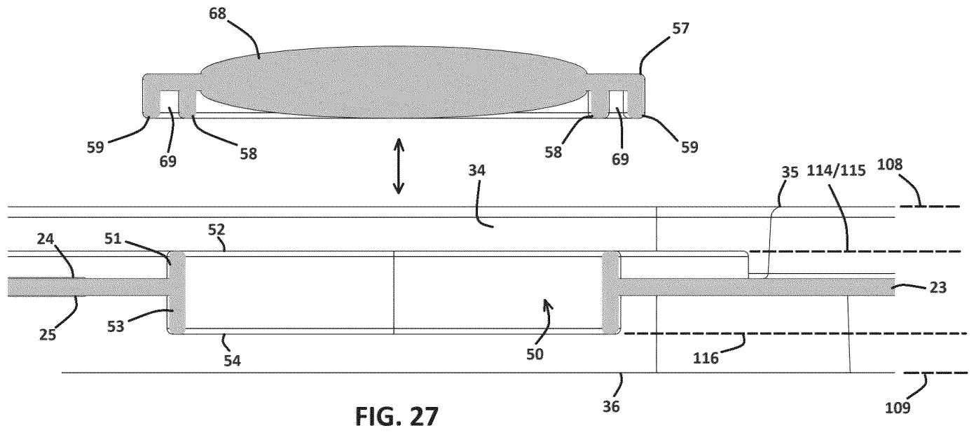

In some embodiments, the walker trays 10, 210 and 310 may each further comprise a removable lens element 57 as generally depicted and referenced in FIGS. 25 through 27. The removable lens element 57 is configured to removably attach to at least the third aperture 50 for refracting light passing therethrough. In some embodiments, the removable lens element 57 may be characterized by comprising a biconvex lens 68 to provide users 200 with a removable magnifying lens feature. In some embodiments, the removable lens element 57 is configured to seat upon the upper peripheral aperture ridge formation 51. In this regard, the removable lens element 57 may comprise a downwardly extending inner peripheral edge 58 and a downwardly extending outer peripheral edge 59 concentric about the inner peripheral edge 58 with a channel 69 therebetween configured to receive the upper peripheral aperture ridge formation 51.

In some embodiments, the upper peripheral edge ridge formation 34, the peripheral aperture ridge formations 78 of the handle-receiving apertures 27, and the upper peripheral aperture ridge formation 51 of the third apertures 50 extend upwardly from the upper tray surface 24 of the tray support portion 23 to corral objects such as writing implements and possibly spilled liquids upon the upper tray surface 24 to prevent the same from falling through the handle-receiving apertures 27 or the third aperture 50. In some embodiments, the upper peripheral aperture ridge formation 51 and the lower peripheral aperture ridge formation 53 are coextensive thereby forming a cylindrical sleeve formation, which cylindrical sleeve formation may operate to receive and hold objects exemplified by a liquid container or other similarly shaped objects, particularly those having a diameter configured to mate with the sleeve formation.

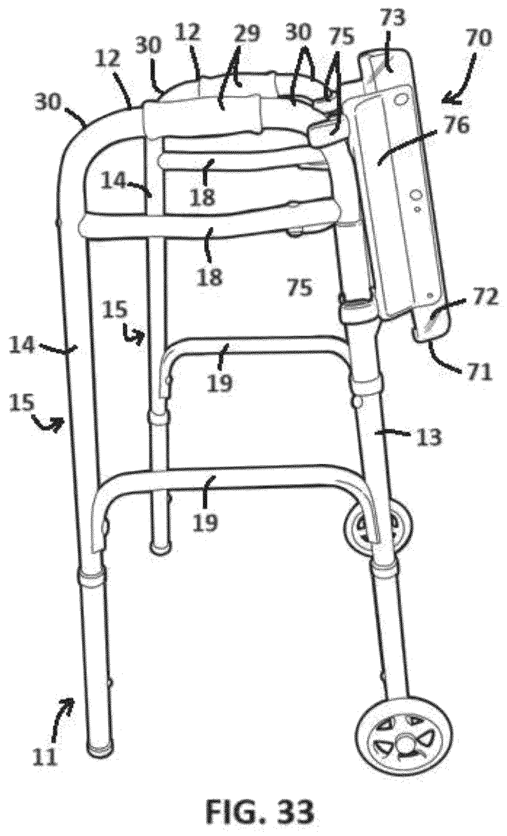

Turning now to the fourth walker tray 70 according to the presently disclosed subject matter, the fourth walker tray 70 is designed for use with either a walker apparatus 11 or a rollator apparatus (not specifically illustrated). The fourth walker tray 70 is generally depicted and referenced in FIGS. 33 through 36. As earlier described, the walker apparatus 11 has laterally opposable handle portions 12 each of which extend in a handle plane 102 having a horizontal dimension. In some embodiments, the handle planes 102 of each handle portion 12 are coplanar and substantially horizontal with the horizontal plane 122 as generally depicted in FIG. 6. In some embodiments, the handle plane(s) 102 are slightly obliquely angled relative to the horizontal as generally depicted in FIG. 32.

Each handle portion 12 is supported within a respective handle plane 102 by way of at least one leg. In some embodiments, each handle portion 12 is supported within a respective handle plane 102 by way of a forward leg 13 and a rearward leg 14. Accordingly, in a preferred application, the walker apparatus 11 comprises two forward legs 13 and two rearward legs 14. Together the forward legs 13 and rearward legs 14 support the handle portions 12 within the handle plane(s) 102. The walker apparatus 11 may also be said to comprise laterally opposed upright leg arrangements 15 each of which comprise from front to back: a forward leg 13, a handle portion 12, and a rearward leg 14 such that the handle portion 12 interconnects the forward leg 13 and the rearward leg 14 of each upright leg arrangement 15 at upper portions thereof.

In some embodiments, the fourth walker tray 70 according to the presently disclosed subject matter is designed to cooperate with a walker apparatus 11 generally formed from a tubular structural material as exemplified by tubular steel or aluminum having a generally uniform cross-sectional diameter as at 107 along the handle portions 12, the forward leg portions 13 and the rearward leg portions 14 particularly at the upper portions of the upright leg arrangements 15. In some embodiments, the forward legs 13 extend in a forward leg plane 103F and the rearward legs 14 extend in a rearward leg plane 103R, which leg planes 103F and 103R are angled relative to one another and a vertical plane as at 121.

In some embodiments, the walker apparatus 11 further comprises a cross-member arrangement 16 extending intermediate the forward legs 13, which forward legs 13 are pivotally attached to the cross-member arrangement 16 of each upright leg arrangement. Laterally opposed pivot limiter elements 17 are connected to the cross-member arrangement 16 and an upper crossbar 18 of each upright leg arrangement 15. The upper crossbars 18 extend intermediate the forward leg 13 and the rearward leg 14 of each upright leg arrangement 15 in inferior adjacency to the handle portion 12 in substantially parallel relation thereto. Each upright leg arrangement 15 may further comprise a lower crossbar 19. The lower crossbars 19 extend intermediate the forward legs 13 and the rearward legs 14 of each upright leg arrangement 15 in inferior adjacency to the upper crossbar 18 in substantially parallel relation thereto.

In some embodiments, the upright leg arrangements 15 are pivotal about a pivot axis of rotation extending through the forward legs 13 at opposite ends of the cross-member arrangement 16. The upright leg arrangements 15 are pivotal so as to allow the user 200 to pivot the same about the pivot axes of rotation in a first rotational direction for configuring the walker apparatus into a first, usage state as generally depicted in FIGS. 28A through 32 and further about the pivot axes of rotation in a direction opposite the first direction for collapsing the walker apparatus 11 into a second, stowage or collapsed state (not specifically illustrated). The fourth walker tray 70 according to the presently disclosed subject matter is attachable to the walker apparatus 11 when in the first, usage state and removable therefrom before reconfiguring the walker apparatus 11 into the second, stowage or collapsed state.

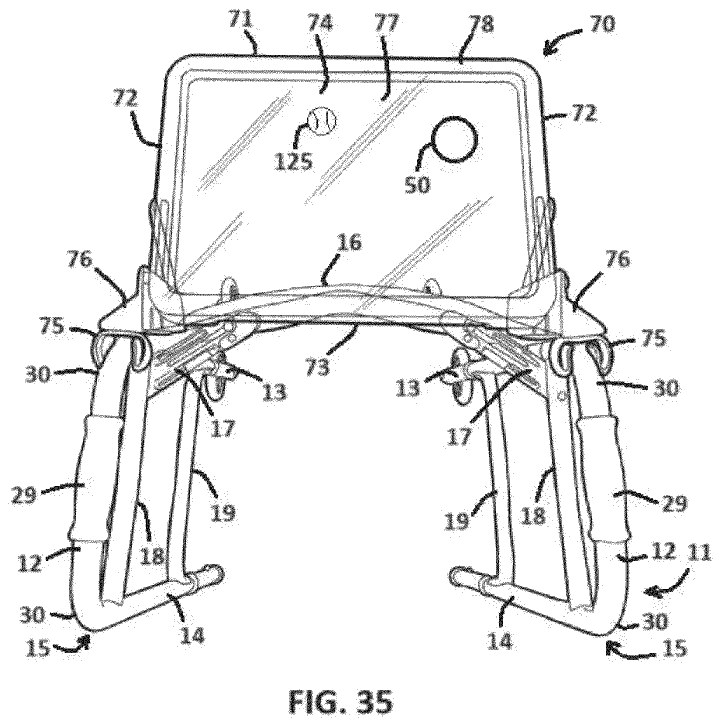

In some embodiments, the fourth walker tray 70 is formed from an injection molding process using a light-transmissive material exemplified by polycarbonate or acrylic materials. Such materials enable injection molding processes and provide a lightweight yet durable material construction. They further provide light-transmittance through the fourth walker tray 70 and an ability to add a wide range of color tones to the material while maintaining light-transmittivity thereof for enabling a user 200 to see through at least a portion of the fourth walker tray 70 to see or visibly perceive objects thereunder as exemplified by a ball as at 125 in FIG. 35.

As with the walker trays 10, 210 and 310, it is here noted that a preferred manufacturing process for the fourth walker tray 70 is also by way of an injection-molding process, at least in part. This should not be construed as limiting, but rather exemplary. Other types of suitable manufacturing processes include, but are not limited to CNC machining, thermoset manufacturing, rotational molding, thermoforming, 3D printing, extrusion, and vacuum forming processes, the last of which is notably one of the most widely-used methods of thermoforming, a common alternative to injection molding.

The fourth walker tray 70 is designed to be mounted or installed upon a walker apparatus as variously depicted and referenced at 11 and in this regard, comprises a second tray-to-walker attachment mechanism configured to removably attach the fourth walker tray 70 to the walker apparatus 11 so as to position a tray support portion 74 thereof in a support plane 160 so as to provide a horizontal support surface for enabling a user to support items thereupon. In some embodiments, the second tray-to-walker attachment mechanism may be characterized by a plurality of resilient clip elements 75 extending from at least two portions of a forward portion 71, a rearward portion 73, and laterally opposed portions 72 of the fourth walker tray 70. The resilient clip elements 75 are attached to at least first and second portions of the forward portion 71, the rearward portion 73, and laterally opposed portions 72 and also the walker apparatus 11. In some embodiments, the resilient clip elements 75 are attached to the laterally opposed portions 72 and either the forward legs 13 or rearward legs 14 of the walker apparatus 11 as the user 200 may elect.

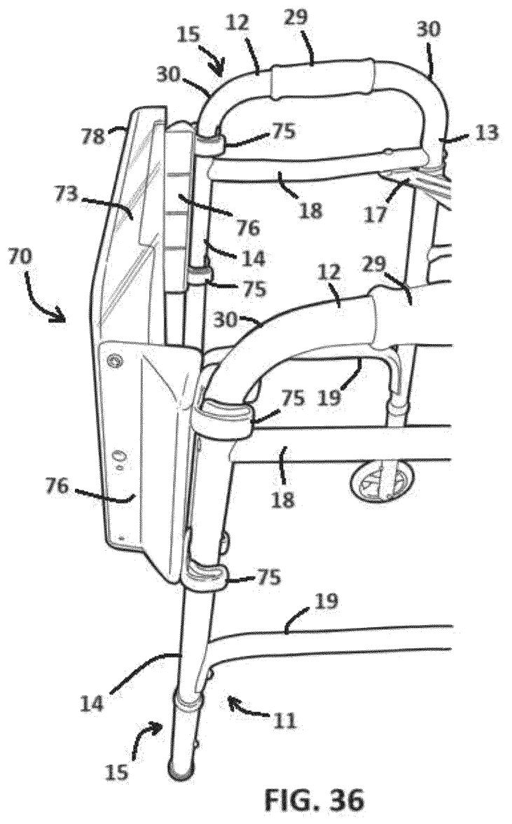

In some embodiments, the plurality of resilient clip elements 75 comprise paired sets of clip elements extending from at least two portions of the forward portion 71, the rearward portion 73, and the laterally opposed portions 72. In some embodiments, each paired set of resilient clip elements 75 extend from the laterally opposed portions 72. In some embodiments, the resilient clip elements 75 attach the fourth walker tray 70 to the front legs 13 as generally depicted in FIG. 33 through 35; and in some embodiments, the resilient clip elements 75 attach the fourth walker tray 70 to the rear legs 14 attach the fourth walker tray 70 as generally depicted in FIG. 36.

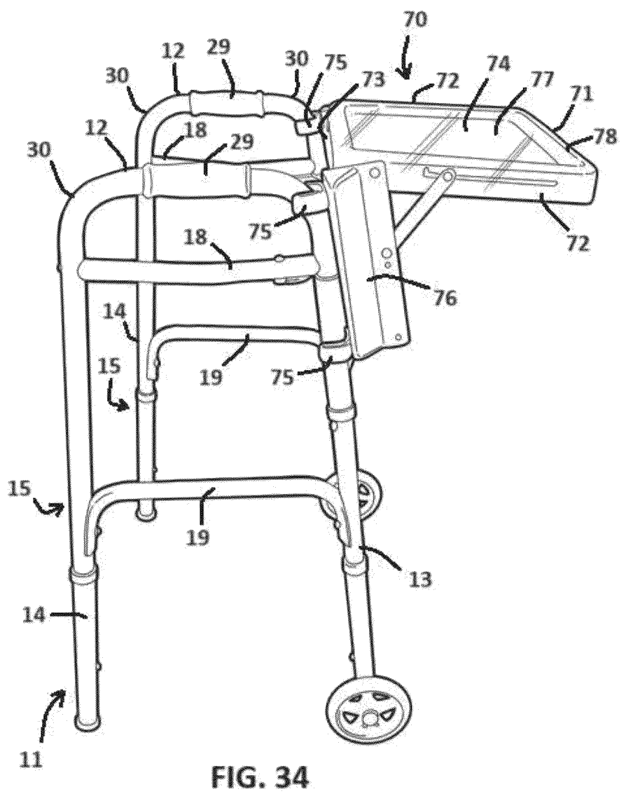

Recalling the walker apparatus 11 comprises a tubular structural material as exemplified by tubular steel or aluminum having a generally uniform cross-sectional diameter as at 107, the resilient clip elements 75 are configured to clip on to either of the front legs 13 or the rear legs 14 across the cross-sectional diameter 107. In some embodiments, each paired set of clip elements 75 extend from a main clip body 76. In some embodiments, each main clip body 76 is pivotally attached a respective laterally opposed portion 72. Accordingly, in some embodiments, the tray support portion 74 is pivotal intermediate an object support configuration characterized by a horizontal orientation as generally depicted in FIGS. 34 and 35, and a collapsed configuration characterized by at least a partially vertical orientation as generally depicted in FIGS. 33 and 36.

In some embodiments, the fourth walker tray 20 according to the presently disclosed subject matter comprises is formed from a material suitable for injection-molding formation. In some embodiments, the material may be polycarbonate or acrylic. The fourth walker tray 70 as formed from any suitable material comprises a forward edge, side, or portion as at 71, a rearward edge, side or portion 73, laterally opposed edges, sides or portions 72, and a tray support portion 74 extending intermediate the forward portion 71, the rearward portion 73, and the laterally opposed portions 72.

In some embodiments, at least one of the forward portion 71, the rearward portion 73, and the laterally opposed portions 72 may comprise a hanger mechanism for enabling a user 200 to hang a utility bag as at 60 or other hangable items upon the fourth walker tray 70. In some embodiments, the hanger mechanism may be characterized by at least one of a strap-receiving aperture as at 61 and a loop supporting hook member as at 62. In other words, in some embodiments, the fourth walker tray 70 may comprise or include integrally molded hook members 62. Although not specifically illustrated as such, the hook members 62 of the fourth walker tray 70 may be positioned along the rearward portion 73 adjacent the laterally opposed portions 72. However, the hook members 62 may be located on any of the forward, rearward or laterally opposed portions 71, 73, 72 of the fourth walker tray 70.

It is noted that many users 200 of walker apparatuses 11 will purchase an accessory or utility bag as at 60 that may be hung from the frame of the walker apparatus 11. Typically, these accessory or utility bags 60 are hung from one of the sides or the front of the frame. This mounting location requires the user 200, once seated, to move the walker apparatus 11 to gain access to the bag 60. This can be difficult for some users 200 who lack upper body strength. By adding an accessory mounting hanger mechanism as exemplified by strap-receiving apertures 61 or hook members 62 on the rearward portion 73 opposite the user 200, the bag 60 may face the user 200 once seated and does not require the user to manipulate the walker apparatus 11 to gain access to the storage pockets as at 63. Straps 64 of the utility bag 60 may be inserted through the strap-receiving apertures 61 and around the rearward legs 14 to hang the utility bag 60 from the fourth walker tray 70 and attach the same to the walker apparatus 11. The utility bag 60 may further comprise other attachment mechanisms such as a loop member as at 65 in FIG. 31.

Central to the practice of the invention is the tray support portion 74, which extends intermediate the forward portion 71, the rearward portion 73 and the laterally opposed portions 72 and is configured to support objects placed thereupon (not specifically illustrated). The tray support portion 74 comprises an upper tray surface 77 and a lower tray surface with a substantially uniform tray support thickness extending therebetween. In some embodiments, the tray support portion 74 is substantially planar with a substantially uniform tray thickness within a thickness range of 3 to 5 millimeters. In some embodiments, at least the tray support portion 74 is formed from a light-transmissive material for allowing light to pass therethrough and for enabling a user 200 to see through at least the tray support portion 74 as variously described herein.

In some embodiments, the fourth walker tray 70 may be formed by way of an injection molding process and according in some embodiments, the entirety of the fourth walker tray 70 is formed from a light-transmissive material for allowing light to pass therethrough, including the forward portion 71, the rearward portion 73, the laterally opposed edges 72, the tray support portion 74, and the main clip bodies 76. In some embodiments, at least the tray support portion 74 is formed from a colored light-transmissive material for coloring and altering a light-transmittance thereof. In some embodiments, for example, the colored light-transmissive material may be of blue coloration as depicted at hatch marking 55 in FIG. 7A, and in some embodiments the colored light-transmissive material may be of purple coloration as depicted at hatch marking 56 in FIG. 7B.

In this last regard, it is noted the visible spectrum is the band of the electromagnetic spectrum that is visible to the human eye. Electromagnetic radiation within this range of wavelengths is called visible light or more simply “light”. A typical human eye will respond to wavelengths from about 380 nanometers (at the ultraviolet end of the spectrum) to about 750 nanometers at (the infrared end of the spectrum). As earlier stated, one possible material for the walker tray is polycarbonate, which exhibits roughly 85% to 90% transmission of visible light within the visible spectrum. Another possible material for the fourth walker tray 70 is acrylic, which exhibits roughly 92% transmission of visible light within the visible spectrum.

Accordingly, in some embodiments, the fourth walker tray 70 and at least the tray support portion 74 may be said to exhibit light transmittance within this range and thus may be said to provide a translucent walker tray or at least a translucent tray support portion 74 for enabling users 200 to see therethrough while simultaneously providing some limited degree of non-transparency or opacity so that users 200 are able to visibly discern the structure of the fourth walker tray 70. While other materials may be used in the formation of the fourth walker tray 70, a central aspect of the presently disclosed subject matter is to provide a tray support portion 74 that provides translucency for enabling a user 200 to see through at least a portion of the fourth walker tray 70 for improving overall safety of use of a walker apparatus 11 with the fourth walker tray 70 installed thereupon.

In some embodiments, the fourth walker tray 70 according to the presently disclosed subject matter further comprises an upper peripheral edge ridge formation 78 extending along the forward portion 71, the rearward portion 73, and laterally opposed portions 72 such that an upper edge portion of the upper peripheral edge ridge formation 78 extends in an upper edge plane in parallel relation to the upper tray surface 77. In some embodiments, the tray support portion 74 extends intermediate the upper peripheral edge ridge formation 78, which terminates upwardly at the upper edge portion thereof.

In some embodiments, the fourth walker tray 70 may further comprises an aperture 50 extending through the tray support portion 74 as otherwise described in connection with the walker trays 10, 210 and 310. In some embodiments, the aperture 50 is circular in form and comprises an aperture diameter as at 136. In some embodiments, the aperture diameter 136 is on the order of 75 to 80 millimeters. In some embodiments, the aperture 50 comprises an upper peripheral aperture ridge formation 51 such that an upper ridge portion 52 of the upper peripheral aperture ridge formation 51 extends in an upper ridge plane 115 intermediate the upper tray surface 77 and the upper edge plane of the upper peripheral edge ridge formation 78 in parallel relation thereto.

In some embodiments, the fourth walker tray 70 may further comprise a removable lens element 57 as generally depicted and referenced in FIGS. 25 through 27. The removable lens element 57 is configured to removably attach to at least the aperture 50 for refracting light passing therethrough. In some embodiments, the removable lens element 57 may be characterized by comprising a biconvex lens 68 to provide users 200 with a removable magnifying lens feature. In some embodiments, the removable lens element 57 is configured to seat upon upper peripheral aperture ridge formation 51. In this regard, the removable lens element 57 may comprise a downwardly extending inner peripheral edge 58 and a downwardly extending outer peripheral edge 59 concentric about the inner peripheral edge 58 with a channel 69 therebetween configured to receive the upper peripheral aperture ridge formation 51.

In some embodiments, the upper peripheral aperture ridge formation 51 of the aperture 50 extends upwardly from the upper tray surface 77 of the tray support portion 74 to corral objects such as writing implements and possibly spilled liquids upon the upper tray surface 77 to prevent the same from falling through the aperture 50. In some embodiments, the upper peripheral aperture ridge formation 51 and the lower peripheral aperture ridge formation 53 are coextensive thereby forming a cylindrical sleeve formation, which cylindrical sleeve formation may operate to receive and hold objects exemplified by a liquid container or other similarly shaped objects, particularly those having a diameter configured to mate with the sleeve formation.

While the above descriptions contain much specificity, this specificity should not be construed as limitations on the scope of the presently disclosed subject matter, but rather as an exemplification thereof. In certain embodiments, the presently disclosed subject matter may be said to essentially teach or disclose a walker tray for use with a walker apparatus having opposable handle portions each of which are supported by a forward leg and a rearward leg together defining a handle portion plane. The walker tray according to the presently disclosed subject matter may be said to essentially comprise a forward portion, a rearward portion, laterally opposed portions, and a tray support portion extending intermediate said forward, rearward, and laterally opposed portions.

The tray support portion has a medial tray plane extending equidistant intermediate the laterally opposed portions and a support plane extending orthogonally relative to the medial tray plane. A pair of laterally opposed handle-receiving apertures extend through the tray support portion inwardly adjacent the laterally opposed portions each of which extend along an aperture plane intersecting the forward and rearward portions. The handle-receiving apertures each have an aperture length extending along a respective aperture plane and an aperture width extending orthogonally relative to the aperture planes. The aperture lengths and the aperture widths are configured to receive the opposable handle portions in either of two handle configurations characterized by a parallel handle configuration and an oblique handle configuration.

In some embodiments, at least the tray support portion is formed from a light-transmissive material for allowing light to pass therethrough and for enabling a user to see through at least the tray support portion of the walker tray. In some embodiments, each handle-receiving aperture comprises a semicircular portion inwardly adjacent the forward portion and the rearward portion. The semicircular portions are each defined by a semicircular diameter equal to the aperture width and a semicircular radius extending orthogonally relative to the aperture diameter coplanar with a respective aperture plane. In some embodiments, the semicircular radii are (a) coplanar with the handle portion planes when in a first handle configuration of the two handle configurations and (b) obliquely angled relative to the handle portion planes when in a second handle configuration of the two handle configurations.

In some embodiments, the aperture planes are obliquely angled relative to the medial tray plane. In some embodiments, each of the handle-receiving apertures is defined inwardly by an inner leg-engaging edge configured to engage a forward leg portion and a rearward leg portion. In some embodiments, the forward and rearward leg portions and the inner leg-engaging edges wedge-support the walker tray upon the walker apparatus. In some embodiments, outer upper portions of the forward legs engage outer portions of the semicircular portions at forward ends along the inner leg-engaging edge and inner upper portions of the rearward legs engage inner portions of the of the semicircular portions at rearward ends along the inner leg-engaging edge when in the parallel handle configuration. In some embodiments, forward upper portions of the forward legs engage forward portions of the semicircular portions at forward ends thereof along the inner leg-engaging edge and rearward upper portions of the rearward legs engage rearward portions of the semicircular portions at rearward ends thereof along the inner leg-engaging edge when in the oblique handle configuration.

In some embodiments, each of the handle-receiving apertures is defined inwardly by an inner leg-engaging edge configured to engage a forward leg portion and a rearward leg portion. In some embodiments, the forward and rearward leg portions and the inner leg-engaging edges wedge-support the walker tray upon the walker apparatus. In some embodiments, inner upper portions of the forward legs engage inner portions of the semicircular portions at forward ends along the inner leg-engaging edge and outer upper portions of the rearward legs engage outer portions of the of the semicircular portions at rearward ends along the inner leg-engaging edge when in the parallel handle configuration. In some embodiments, forward upper portions of the forward legs engage forward portions of the semicircular portions at forward ends thereof along the inner leg-engaging edge and rearward upper portions of the rearward legs engage rearward portions of the semicircular portions at rearward ends thereof along the inner leg-engaging edge when in the oblique handle configuration.

In some embodiments, each of the handle-receiving apertures is defined inwardly by an inner leg-engaging edge configured to engage at least a forward leg portion and a rearward leg portion, said forward and rearward leg portions and said inner leg-engaging edges wedge-support the walker tray upon the walker apparatus. In some embodiments, forward upper portions of the forward legs engage forward portions of the semicircular portions at forward ends thereof along the inner leg-engaging edge and rearward upper portions of the rearward legs engage rearward portions of the semicircular portions at rearward ends thereof along the inner leg-engaging edge when in the parallel handle configuration.

In some embodiments, upper portions of the forward legs engage either inner or outer portions of the semicircular portions at forward ends along the inner leg-engaging edge and upper portions of the rearward legs engage either inner or outer portions of the semicircular portions at rearward ends along the inner leg-engaging edge when in the oblique handle configuration. In some embodiments, the walker tray may further comprise a removable lens element and at least a third aperture extending through the tray support portion. The removable lens element is configured to removably attach to at least the third aperture for refracting light passing therethrough. In some embodiments, at least one of the forward and rearward portions comprises a hanger mechanism configured to hang hangable items upon the walker tray.

There is provided in accordance with another embodiment according to the presently disclosed subject matter a walker tray for use with a walker apparatus having opposable handle portions supported within a respective handle plane. The walker tray comprises a forward portion, a rearward portion, laterally opposed portions, and a tray support portion extending intermediate said forward, rearward, and laterally opposed portions. The tray support portion has a medial tray plane extending equidistant intermediate the laterally opposed portions and a support plane extending obliquely relative to the medial tray plane. At least the tray support portion is formed from a light-transmissive material for allowing light to pass therethrough thereby enabling a user to see through at least the tray support portion of the walker tray.

The walker tray further comprises a tray-to-walker attachment mechanism configured to removably attach the walker tray to the walker apparatus so as to horizontally position the support plane and provide a horizontal support surface for enabling the user to support items thereupon. In some embodiments, the tray-to-walker attachment mechanism is characterized by a pair of laterally opposed handle-receiving apertures extending through the tray support portion inwardly adjacent the laterally opposed portions each of which extend along an aperture plane intersecting the forward and the rearward portions.

In some embodiments, each of the handle-receiving apertures has an aperture length extending along a respective aperture plane and an aperture width extending orthogonally relative thereto, the aperture lengths and aperture widths being configured to receive at least the opposable handle portions in either of two handle configurations characterized by a parallel handle configuration and an oblique handle configuration.

In some embodiments, the opposable handle portions are supported by a forward leg and a rearward leg, which forward and rearward legs are angled relative to one another. Each of the handle-receiving apertures are defined inwardly by an inner leg-engaging edge configured to engage at least a forward leg portion and a rearward leg portion. The forward and rearward leg portions and the inner leg-engaging edges wedge-support the walker tray upon the walker apparatus. In some embodiments, the aperture planes are obliquely angled relative to the medial tray plane.

In some embodiments, the tray-to-walker attachment mechanism is characterized by a plurality of resilient clip elements extending from at least two portions of said forward, rearward, and laterally opposed portions. The resilient clip elements are attachable to at least first and second portions of the walker apparatus. In some embodiments, the plurality of resilient clip elements comprises paired sets of clip elements. Each paired set of clip elements extend from at least two portions of the forward, rearward, and laterally opposed portions. In some embodiments, each paired set of clip elements extend from a main clip body.

Each main clip body is pivotally attached to the laterally opposed portions such that the tray support portion is pivotal intermediate an object support configuration characterized by a horizontal orientation and a collapsed configuration characterized by at least a partially vertical orientation. In some embodiments, the tray support portion comprises at least one aperture and a removable lens element. The removable lens element is configured to removably attach to the at least one aperture for refracting light passing therethrough. In some embodiments, at least one of the forward and rearward portions comprises a hanger mechanism configured to hang hangable items upon the walker tray.

Accordingly, although the presently disclosed subject matter has been described by reference to certain embodiments, it is not intended that the walker trays be limited thereby, but that modifications thereof are intended to be included as falling within the broad scope and spirit of the foregoing disclosures and the appended drawings.

What is claimed is:

1. A walker tray for use with a walker apparatus having opposable handle portions each of which are supported by a forward leg and a rearward leg together defining a handle portion plane, the walker tray comprising:
a forward portion, a rearward portion, laterally opposed portions, and a tray support portion extending intermediate said forward, rearward, and laterally opposed portions;
the tray support portion having a medial tray plane extending equidistant intermediate the laterally opposed portions and a support plane extending orthogonally relative to the medial tray plane;
a pair of laterally opposed handle-receiving apertures extending through the tray support portion inwardly adjacent the laterally opposed portions each of which extend along an aperture plane intersecting the forward and rearward portions;
the handle-receiving apertures each having an aperture length extending along a respective aperture plane and an aperture width extending orthogonally relative to the aperture planes, the aperture lengths and aperture widths being configured to receive the opposable handle portions in either of two handle configurations characterized by a parallel handle configuration and an oblique handle configuration.

2. The walker tray according to claim 1, wherein at least the tray support portion is formed from a light-transmissive material for allowing light to pass therethrough and for enabling a user to see through at least the tray support portion of the walker tray.

3. The walker tray according to claim 1 wherein each handle-receiving aperture comprises a semicircular portion inwardly adjacent the forward portion and the rearward portion, said semicircular portions each being defined by a semicircular diameter equal to the aperture width and a semicircular radius extending orthogonally relative to the aperture diameter coplanar with a respective aperture plane.

4. The walker tray according to claim 3, wherein said semicircular radii are (a) coplanar with the handle portion planes when in a first handle configuration of the two handle configurations and (b) obliquely angled relative to the handle portion planes when in a second handle configuration of the two handle configurations.

5. The walker tray according to claim 4 wherein the aperture planes are obliquely angled relative to the medial tray plane.

6. The walker tray according to claim 4, wherein:
each of the handle-receiving apertures is defined inwardly by an inner leg-engaging edge configured to engage a forward leg portion and a rearward leg portion, said forward and rearward leg portions and said inner leg-engaging edges for wedge-supporting the walker tray upon the walker apparatus such that:
outer upper portions of the forward legs engage outer portions of the semicircular portions at forward ends along the inner leg-engaging edge and inner upper portions of the rearward legs engage inner portions of the of the semicircular portions at rearward ends along the inner leg-engaging edge when in the parallel handle configuration; and
forward upper portions of the forward legs engage forward portions of the semicircular portions at forward ends thereof along the inner leg-engaging edge and rearward upper portions of the rearward legs engage rearward portions of the semicircular portions at rearward ends thereof along the inner leg-engaging edge when in the oblique handle configuration.

7. The walker tray according to claim 4, wherein:
each of the handle-receiving apertures is defined inwardly by an inner leg-engaging edge configured to engage a forward leg portion and a rearward leg portion, said forward and rearward leg portions and said inner leg-engaging edges for wedge-supporting the walker tray upon the walker apparatus such that:
inner upper portions of the forward legs engage inner portions of the semicircular portions at forward ends along the inner leg-engaging edge and outer upper portions of the rearward legs engage outer portions of the of the semicircular portions at rearward ends along the inner leg-engaging edge when in the parallel handle configuration; and
forward upper portions of the forward legs engage forward portions of the semicircular portions at forward ends thereof along the inner leg-engaging edge and rearward upper portions of the rearward legs engage rearward portions of the semicircular portions at rearward ends thereof along the inner leg-engaging edge when in the oblique handle configuration.

8. The walker tray according to claim 4, wherein:
each of the handle-receiving apertures is defined inwardly by an inner leg-engaging edge configured to engage at least a forward leg portion and a rearward leg portion, said forward and rearward leg portions and said inner leg-engaging edges for wedge-supporting the walker tray upon the walker apparatus such that:
forward upper portions of the forward legs engage forward portions of the semicircular portions at forward ends thereof along the inner leg-engaging edge and rearward upper portions of the rearward legs engage rearward portions of the semicircular portions at rearward ends thereof along the inner leg-engaging edge when in the parallel handle configuration; and
upper portions of the forward legs engage either inner or outer portions of the semicircular portions at forward ends along the inner leg-engaging edge and upper portions of the rearward legs engage either inner or outer portions of the semicircular portions at rearward ends along the inner leg-engaging edge when in the oblique handle configuration.

9. The walker tray according to claim 1 comprising a removable lens element and at least a third aperture extending through the tray support portion, the removable lens element being configured to removably attach to at least the third aperture for refracting light passing therethrough.

10. The walker tray according to claim 1, wherein at least one of the forward and rearward portions comprises a hanger mechanism configured to hang hangable items upon the walker tray.

11. A walker tray for use with a walker apparatus having opposable handle portions supported within a respective handle plane, the walker tray comprising:
a forward portion, a rearward portion, laterally opposed portions, and a tray support portion extending intermediate said forward, rearward, and laterally opposed portions;
the tray support portion having a medial tray plane extending equidistant intermediate the laterally opposed portions and a support plane extending obliquely relative to the medial tray plane;
at least the tray support portion being formed from a light-transmissive material for allowing light to pass therethrough and enabling a user to see through at least the tray support portion of the walker tray; and
a tray-to-walker attachment mechanism configured to removably attach the walker tray to the walker apparatus so as to horizontally position the support plane and provide a horizontal support surface for enabling the user to support items thereupon.

12. The walker tray according to claim 11, wherein the tray-to-walker attachment mechanism is characterized by a pair of laterally opposed handle-receiving apertures extending through the tray support portion inwardly adjacent the laterally opposed portions each of which extend along an aperture plane intersecting the forward and the rearward portions.

13. The walker tray according to claim 12, wherein each of the handle-receiving apertures has an aperture length extending along a respective aperture plane and an aperture width extending orthogonally relative thereto, the aperture lengths and aperture widths being configured to receive at least the opposable handle portions in either of two handle configurations characterized by a parallel handle configuration and an oblique handle configuration.

14. The walker tray according to claim 13, wherein the opposable handle portions are supported by a forward leg and a rearward leg, the forward and rearward legs being angled relative to one another, each of the handle-receiving apertures being defined inwardly by an inner leg-engaging edge configured to engage at least a forward leg portion and a rearward leg portion, said forward and rearward leg portions and said inner leg-engaging edges for wedge-supporting the walker tray upon the walker apparatus.

15. The walker tray according to claim 14, wherein the aperture planes are obliquely angled relative to the medial tray plane.

16. The walker tray according to claim 11 wherein the tray support portion comprises at least one aperture and a removable lens element, the removable lens element being configured to removably attach to the at least one aperture for refracting light passing therethrough.

17. The walker tray according to claim 11, wherein at least one of the forward and rearward portions comprises a hanger mechanism configured to hang hangable items upon the walker tray.

18. The walker tray according to claim 11, wherein the tray-to-walker attachment mechanism is characterized by a plurality of resilient clip elements extending from at least two portions of said forward, rearward, and laterally opposed portions, the resilient clip elements being attachable to at least first and second portions of the walker apparatus.

19. The walker tray according to claim 18, wherein the plurality of resilient clip elements comprises paired sets of clip elements, each paired set of clip elements extending from at least two portions of said forward, rearward, and laterally opposed portions.

20. The walker tray according to claim 19, wherein each paired set of clip elements extend from a main clip body, each main clip body being pivotally attached to the laterally opposed portions such that the tray support portion is pivotal intermediate an object support configuration characterized by a horizontal orientation and a collapsed configuration characterized by at least a partially vertical orientation.
